(19) United States
(12) Patent Application Publication
(10) Pub. No.: US 2026/0320360 A1
(43) Pub. Date: Oct. 15, 2026

(54) GENERATIVE MODEL-BASED DYNAMIC CONTENT GENERATION

(71) Applicant: Teikametrics, Inc., Boston, MA (US)

(72) Inventors: Alasdair MCLEAN-FOREMAN, Boston, MA (US); Ryan GOLDSTEIN, San Diego, CA (US); Jonathan KOLB, Medford, MA (US); David GLENN, Providence, UT (US); Christopher ALLEN, Somerville, MA (US); Michael REISS, Windham, NH (US); John Chandler WHITTIER, Camden, ME (US); Cheng QIU, Hoboken, NJ (US)

(73) Assignee: Teikametrics, Inc., Boston, MA (US)

(21) Appl. No.: 19/647,657

(22) Filed: Apr. 14, 2026

Related U.S. Application Data
(60) Provisional application No. 63/789,162, filed on Apr. 15, 2025.

(51) Int. Cl. G06N 3/0475

(52) U.S. Cl. CPC G06N 3/0475

(57) ABSTRACT

A system can include one or more processors to select a plurality of targets regarding a product based at least on performance data regarding the product. The performance data corresponds to completion of an event associated with the product. The system can identify a plurality of selected targets. The system can generate, using a model, content describing the product using the plurality of selected targets. The system can update the content on a destination system.

### CROSS-REFERENCE TO RELATED APPLICATIONS

The present application claims the benefit of and priority to U.S. Provisional Application No. 63/789,162, filed Apr. 15, 2025, the disclosure of which is incorporated herein by reference in its entirety.

### BACKGROUND

This application relates generally to the field of content generation for online channels, and more particularly to generative model-based dynamic content generation.

Online channels that present electronic information may have various formats, including but not limited to webpage formats, web applications, and mobile applications. It can be challenging to structure content and include information in content to be presented via online channels in a manner that achieves performance criteria, such as content that results in electronic event completion such as engagement with content and/or conversion of content to event completion. While some natural language processing systems, including machine learning model (e.g., neural network and/or transformer-based machine learning model) systems can be useful to facilitate content generation, such systems may not generate content that is optimized for such performance criteria.

### SUMMARY

Online channels that present electronic information to users can include web-based applications, online marketplaces, and mobile applications, among others. Content presented via online channels can include text, image, audio, and video content describing products or services. The performance of content on online channels can depend on factors such as audience behavior, channel-specific algorithms, and evolving trends related to search and engagement patterns. Generating content that achieves performance criteria, such as completion of electronic events including engagement with content, navigation from advertisements to product listings, and electronic purchases, can be difficult to scale across multiple products and multiple channels. Conventional approaches to content generation may rely on descriptive product data or simplistic keyword lists that lack a strong linkage to event-completion performance metrics. Natural language processing and natural language generation (NLG) systems can be used to output text for content based on input indicating information to include, but the systems may lack the ability to generate text that meets criteria for syntactical variation or other characteristics of natural, engaging language while conforming to strict and varied channel-specific requirements. The challenges can be compounded by variations among and dynamic changes to the algorithms that online channels use to prioritize or return content in response to queries. As a result, conventional content generation approaches can produce non-compliant listings, lower visibility in search results, and suboptimal performance outcomes that require additional resources to correct.

The techniques described herein can provide a performance-driven target selection pipeline that aggregates candidate semantic targets for a product, associates each target with performance data corresponding to completion of one or more electronic events (for example, purchase events, navigation events from advertisements to listings, or engagement events), and ranks and selects a subset of the targets based at least in part on the performance data. The selected targets can be output for downstream use in content generation and updating, including use by generative artificial intelligence (AI) models such as language models or multimodal models. The techniques described herein can determine semantic relevance between a product and candidate targets using vector embeddings and similarity computations, such as by generating embeddings for product representations and candidate target text and computing cosine similarity between the embeddings to produce a relevance score. The relevance score can be compared to one or more discrimination thresholds to classify targets as relevant or not relevant, and irrelevant targets can be filtered from the candidate set before content generation. The techniques described herein can provide the selected targets as input to one or more generative models to generate content representative of the product, where the generated content can include text, image, audio, speech, and video content customized according to channel parameters for one or more destination channels. The generated content can be synchronized to the destination channels and monitored for performance, and subsequent updates to the content can be caused according to monitored performance metrics or dynamic conditions such as seasonality, trend data, or audience data.

At least one aspect relates to a system of dynamic content generation. The system can include one or more processors. The system can obtain a plurality of candidate targets for generation of content to update on an electronic resource associated with an object. The system can classify each candidate target of the plurality of candidate targets according to at least one of a source of the candidate target or a category of the candidate target. The system can assign, to each candidate target of the plurality of candidate targets, a tag according to the classification of the candidate target. The system can score, for each candidate target of the plurality of candidate targets, a relevance to the object of the candidate target. The system can filter the plurality of candidate targets based at least on the relevance of each candidate target of the plurality of candidate targets to generate a subset of candidate targets of the plurality of candidate targets. The system can obtain, for presentation on a user interface of the electronic resource, at least one of a template of a content item regarding the object or predetermined content regarding the object on the electronic resource. The system can cause at least one of a large language model (LLM) or a vision language model (VLM) to generate content data comprising at least one candidate target of the subset of candidate targets. The system can transmit a synchronization command to a system of the electronic resource to synchronize the content data to the electronic resource, the synchronization command comprising the content data and instructions to populate one or more content items associated with the object for presentation of the content data on the user interface.

In some implementations, the system can obtain performance data regarding one or more candidate targets of the plurality of candidate targets. In some implementations, the system can filter the plurality of candidate targets based at least on the performance data and a weight for the performance data selected according to a level of aggregation of the performance data relative to the object. In some implementations, the system can cause the at least one of the LLM or the VLM to generate the content data using a structure of the one or more content items on the user interface. In some implementations, the system can extract at least a subset of the plurality of candidate targets from one or more data sources that provide the subset without performance data relating the subset to the object. In some implementations, the system can filter according to the relevance and a threshold defined according to a false positive score and a false negative score regarding a plurality of example pairs of example targets and example target objects. In some implementations, the system can group each candidate target of the plurality of candidate targets according to the tag of the candidate target. In some implementations, the system can rank the plurality of candidate targets within each group. In some implementations, the system can filter the plurality of candidate targets without using historical performance data regarding performance of the plurality of candidate targets with respect to completion of one or more events associated with the object. In some implementations, the system can score the relevance of the plurality of candidate targets based at least on normalizing the relevance within each group. In some implementations, the system can detect performance data of one or more candidate targets of the plurality of candidate targets with respect to completion of at least one event regarding the object, the at least one event comprising an engagement action via a user interface to the electronic resource.

At least one other aspect relates to a method of dynamic content generation. The method can be performed, for example, by one or more processors coupled to non-transitory memory. The method can include obtaining a plurality of candidate targets for generation of content to update on an electronic resource associated with an object. The method can include classifying each candidate target of the plurality of candidate targets according to at least one of a source of the candidate target or a category of the candidate target. The method can include assigning, to each candidate target of the plurality of candidate targets, a tag according to the classification of the candidate target. The method can include scoring, for each candidate target of the plurality of candidate targets, a relevance of the candidate target to the object. The method can include filtering the plurality of candidate targets based at least on the relevance of each candidate target of the plurality of candidate targets to generate a subset of candidate targets of the plurality of candidate targets. The method can include obtaining, for presentation on a user interface of the electronic resource, at least one of a template of a content item regarding the object or predetermined content regarding the object on the electronic resource. The method can include causing at least one of a large language model (LLM) or a vision language model (VLM) to generate content data comprising at least one candidate target of the subset of candidate targets. The method can include transmitting a synchronization command to a system of the electronic resource to synchronize the content data to the electronic resource, the synchronization command comprising the content data and instructions to populate one or more content items associated with the object for presentation of the content data on the user interface.

In some implementations, the method can include obtaining performance data regarding one or more candidate targets of the plurality of candidate targets. In some implementations, the method can include filtering the plurality of candidate targets based at least on the performance data and a weight for the performance data selected according to a level of aggregation of the performance data relative to the object. In some implementations, the method can include extracting at least a subset of the plurality of candidate targets from one or more data sources that provide the subset without performance data relating the subset to the object. In some implementations, the method can include filtering the plurality of candidate targets according to the relevance and a threshold defined according to a false positive score and a false negative score regarding a plurality of example pairs of example targets and example target objects. In some implementations, the method can include grouping each candidate target of the plurality of candidate targets according to the tag of the candidate target. In some implementations, the method can include ranking the plurality of candidate targets within each group. In some implementations, the method can include filtering the plurality of candidate targets without using historical performance data regarding performance of the plurality of candidate targets with respect to completion of one or more events associated with the object. In some implementations, the method can include grouping each candidate target of the plurality of candidate targets according to the tag of the candidate target. In some implementations, the method can include scoring the relevance of the plurality of candidate targets based at least on normalizing the relevance within each group. In some implementations, the method can include detecting performance data of one or more candidate targets of the plurality of candidate targets with respect to completion of at least one event regarding the object, the at least one event comprising an engagement action via a user interface to the electronic resource.

At least one other aspect relates to a non-transitory computer-readable medium comprising machine-readable instructions that when executed by one or more processors, cause the one or more processors to perform operations. The operations can include scoring, for each candidate target of a plurality of candidate targets for content generation regarding an object, a relevance of the candidate target to the object. The operations can include filtering the plurality of candidate targets based at least on the relevance of each candidate target of the plurality of candidate targets to generate a subset of candidate targets of the plurality of candidate targets. The operations can include causing at least one of a large language model (LLM) or a vision language model (VLM) to generate content data comprising at least one candidate target of the subset of candidate targets, according to at least one of a graphical user interface template for presentation of the content data using an electronic resource or predetermined content regarding the presentation of the content data using the electronic resource. The operations can include synchronizing the content data to the electronic resource.

In some implementations, the operations can include filtering the plurality of candidate targets without using historical performance data regarding performance of at least one candidate target of the plurality of candidate targets with respect to completion of one or more events associated with the object. In some implementations, the operations can include maintaining a listing of each of the plurality of candidate targets. In some implementations, the operations can include presenting, on a first interface, the subset of candidate targets. In some implementations, the operations can include presenting, on a second interface responsive to a request received via the first interface, the listing of each of the plurality of candidate targets.

At least one other aspect relates to a system of dynamic content generation. The system can include one or more processors. The system can obtain a plurality of candidate targets for generation of content to update on an electronic resource associated with an object. The system can generate, using at least one embedding model, a candidate vector embedding for each candidate target of the plurality of candidate targets. The system can generate, using the at least one embedding model, an object vector embedding according to data regarding the object. The system can score, for each candidate target of the plurality of candidate targets, a relevance to the object, according to the candidate vector embedding and the object vector embedding. The system can filter the plurality of candidate targets based at least on the relevance of each candidate target of the plurality of candidate targets to generate a subset of candidate targets of the plurality of candidate targets. The system can cause at least one of a large language model (LLM) or a vision language model (VLM) to generate content data comprising at least one candidate target of the subset of candidate targets. The system can transmit a synchronization command to a system of the electronic resource to synchronize the content data to the electronic resource, the synchronization command comprising the content data and instructions to populate one or more content items associated with the object.

In some implementations, the data regarding the object comprises at least one of a title, an image, a description, one or more attributes, or metadata of the object. In some implementations, the system can filter the plurality of candidate targets based at least on the relevance and at least one threshold that is learned over positive examples and negative examples of target-object pairs. In some implementations, the at least one embedding model is selected according to a discrimination performance with respect to a plurality of example target-object pairs. In some implementations, the system can score the relevance based at least on a language of the plurality of candidate targets. In some implementations, the system can filter the plurality of candidate targets based at least on weighting of false positives and weighting false negatives. In some implementations, the system can score the relevance based at least on determining a similarity between the candidate vector embedding and the object vector embedding. In some implementations, the system can determine the candidate vector embedding and the object vector embedding in a same vector space. In some implementations, the candidate target comprises data of a first modality, and the data regarding the object is of at least one second modality different from the first modality. In some implementations, the system can classify each candidate target of the plurality of candidate targets according to at least one of a source of the candidate target or a category of the candidate target. In some implementations, the system can assign, to each candidate target of the plurality of candidate targets, a tag according to the classification of the candidate target. In some implementations, the system can filter the plurality of candidate targets based at least on the tag.

At least one other aspect relates to a method of dynamic content generation. The method can be performed, for example, by one or more processors coupled to non-transitory memory. The method can include obtaining a plurality of candidate targets for generation of content to update on an electronic resource associated with an object. The method can include generating, using at least one embedding model, a candidate vector embedding for each candidate target of the plurality of candidate targets. The method can include generating, using the at least one embedding model, an object vector embedding according to data regarding the object. The method can include scoring, for each candidate target of the plurality of candidate targets, a relevance to the object, according to the candidate vector embedding and the object vector embedding. The method can include filtering the plurality of candidate targets based at least on the relevance of each candidate target of the plurality of candidate targets to generate a subset of candidate targets of the plurality of candidate targets. The method can include causing at least one of a large language model (LLM) or a vision language model (VLM) to generate content data comprising at least one candidate target of the subset of candidate targets. The method can include transmitting a synchronization command to a system of the electronic resource to synchronize the content data to the electronic resource, the synchronization command comprising the content data and instructions to populate one or more content items associated with the object.

In some implementations, the data regarding the object comprises at least one of a title, an image, a description, one or more attributes, or metadata of the object. In some implementations, the method can include filtering the plurality of candidate targets based at least on the relevance and at least one threshold that is learned over positive examples and negative examples of target-object pairs. In some implementations, the method can include selecting the at least one embedding model according to a discrimination performance with respect to a plurality of example target-object pairs. In some implementations, the method can include scoring the relevance based at least on a language of the plurality of candidate targets. In some implementations, the method can include filtering the plurality of candidate targets based at least on weighting of false positives and weighting false negatives. In some implementations, the method can include scoring the relevance based at least on determining a similarity between the candidate vector embedding and the object vector embedding. In some implementations, the method can include computing the candidate vector embedding and the object vector embedding in a same vector space. In some implementations, the candidate target comprises data of a first modality, and the data regarding the object is of at least one second modality different from the first modality. In some implementations, the method can include classifying each candidate target of the plurality of candidate targets according to at least one of a source of the candidate target or a category of the candidate target. In some implementations, the method can include assigning, to each candidate target of the plurality of candidate targets, a tag according to the classification of the candidate target. In some implementations, the method can include filtering the plurality of candidate targets based at least on the tag.

At least one other aspect relates to a system of performance-driven content generation. The system can include one or more processors. The system can identify a plurality of content items arranged for presentation of an object via an electronic resource, each content item of the plurality of content items structured to represent at least one of text data, image data, or video data. The system can select a plurality of targets having at least a threshold value for a performance metric for completion of one or more events relating to the object via at least one interface of the electronic resource. The system can assign each target of the plurality of targets to at least one corresponding content item of the plurality of content items. The system can cause at least one of a large language model (LLM) or vision language model (VLM) to generate a content output for each content item using the target assigned to the content item, to obtain an updated content representation for the object. The system can synchronize the updated content representation to the electronic resource for presentation of the updated content representation via the at least one interface.

In some implementations, the system can cause the at least one of the LLM or the VLM to generate the content output for each content item based on at least one of a character limit or a pixel limit for presentation of the plurality of content items via the at least one interface. In some implementations, the electronic resource is a first electronic resource, and the system can select the plurality of targets to include a plurality of first targets for the first electronic resource and a plurality of second targets for the second electronic resource. In some implementations, the system can generate the content output as a first content output for the first electronic resource. In some implementations, the system can generate a second content output for the second electronic resource using the plurality of second targets. In some implementations, the system can synchronize each of the first content output to the first electronic resource and the second content output to the second electronic resource. In some implementations, the plurality of content items comprise at least a title item and a narrative description item. In some implementations, the system can periodically update the plurality of targets according to the performance metric for the plurality of targets. In some implementations, the system can refresh the updated content representation according to the update of the plurality of targets. In some implementations, the system can present a user interface that comprises each of a current state of the content representation and the updated content representation, in which the plurality of targets are provided with a modified graphical identifier relative to corresponding content of the current state. In some implementations, the object is of a plurality of objects, and the system can select the plurality of targets to correspond to a threshold level of performance for the plurality of objects. In some implementations, the system can synchronize respective updated content representations for each of the plurality of objects in response to a single input command. In some implementations, the system can present a user interface that indicates a current state of the content representation and a state of updating of the current state relative to the plurality of targets. In some implementations, the system can periodically monitor the electronic resource to validate the synchronization of the updated content representation to the electronic resource. In some implementations, each content item of the plurality of content items comprises at least one of a field or a portion of a user interface element. In some implementations, the system can present an interface for manual editing of the content, based at least on receiving a command for manual editing. In some implementations, the system can cause an update of the updated content representation on the electronic resource based at least on receiving a command, at the interface, for updating the content. In some implementations, the system can monitor a description of the object and performance data regarding the object to detect a content generation condition. In some implementations, the system can present a recommendation to update the description to include the plurality of selected targets responsive to detecting the content generation condition. In some implementations, the system can cause the at least one of the LLM or the VLM to generate the content output to include at least one of image, audio, speech, video, or a representation of a person, regarding the object. In some implementations, the system can generate at least one of the plurality of targets or the content output based on at least one of a text description of the object, an image of the object, audio regarding the object, or a video of the object.

At least one other aspect relates to a method of performance-driven content generation. The method can be performed, for example, by one or more processors coupled to non-transitory memory. The method can include identifying a plurality of content items arranged for presentation of an object via an electronic resource, each content item of the plurality of content items structured to represent at least one of text data, image data, or video data. The method can include selecting a plurality of targets having at least a threshold value for a performance metric for completion of one or more events relating to the object via at least one interface of the electronic resource. The method can include assigning each target of the plurality of targets to at least one corresponding content item of the plurality of content items. The method can include causing at least one of a large language model (LLM) or vision language model (VLM) to generate a content output for each content item using the target assigned to the content item, to obtain an updated content representation for the object. The method can include synchronizing the updated content representation to the electronic resource for presentation of the updated content representation via the at least one interface.

In some implementations, the plurality of content items comprise at least a title item and a narrative description item. In some implementations, the method can include periodically updating the plurality of targets according to the performance metric for the plurality of targets. In some implementations, the method can include resynchronizing the updated content representation according to the update of the plurality of targets. In some implementations, the method can include presenting a user interface that comprises each of a current state of the content representation and the updated content representation, in which the plurality of targets are provided with a modified graphical identifier relative to corresponding content of the current state. In some implementations, the method can include presenting a user interface that indicates a current state of the content representation and a state of updating of the current state relative to the plurality of targets. In some implementations, the method can include presenting an interface for manual editing of the content, based at least on receiving a command for manual editing. In some implementations, the method can include causing an update of the updated content representation on the electronic resource based at least on receiving a command, at the interface, for updating the content.

At least one other aspect relates to a system. The system can include one or more processors. The system can select a destination channel for synchronization of content to the destination channel. The system can detect a plurality of parameters of the destination channel, the plurality of parameters comprising at least one of a natural language description or a machine-readable description, for at least one of a structure, a syntax, or a format for the content. The system can cause at least one of a large language model (LLM) or a vision language model (VLM) to generate content comprising a plurality of items regarding an object, based at least on a plurality of targets selected for the object and the plurality of parameters, each content item corresponding to one or more respective parameters of the plurality of parameters. The system can transmit a synchronization signal to the destination channel, the synchronization signal comprising instructions to update a data structure regarding the object according to the content.

In some implementations, the system can use the at least one of the LLM or the VLM to validate the content against the plurality of parameters. In some implementations, the system can cause the transmission of the synchronization signal based at least on the validation of the content. In some implementations, the system can cause the at least one of the LLM or the VLM to map each target of the plurality of targets to at least one corresponding item of the plurality of items based at least on the plurality of parameters. In some implementations, the plurality of parameters comprise one or more of a content size constraint, a restriction on characters, or an optional guideline. In some implementations, the system can use the at least one of the LLM or the VLM to parse one or more policy documents to extract the plurality of parameters. In some implementations, the system can assign a first target of the plurality of targets to a first item of the plurality of items and assign a second target of the plurality of targets to a second item of the plurality of items, based at least on the plurality of parameters. In some implementations, the system can perform a validation of the content relative to the plurality of parameters, and output an error responsive to detecting noncompliance of the content relative to the plurality of parameters.

At least one other aspect relates to a method. The method can be performed, for example, by one or more processors coupled to non-transitory memory. The method can include selecting a destination channel for synchronization of content to the destination channel. The method can include detecting a plurality of parameters of the channel, the plurality of parameters comprising at least one of a natural language description or a machine-readable description, for at least one of a structure, a syntax, or a format for the content. The method can include causing at least one of a large language model (LLM) or a vision language model (VLM) to generate content comprising a plurality of items regarding an object, based at least on a plurality of targets selected for the object and the plurality of parameters, each content item corresponding to one or more respective parameters of the plurality of parameters. The method can include transmitting a synchronization signal to the destination channel, the synchronization signal comprising instructions to update a data structure regarding the object according to the content.

In some implementations, the method can include using the at least one of the LLM or the VLM to validate the content against the plurality of parameters. In some implementations, the method can include causing the transmission of the synchronization signal based at least on the validation of the content. In some implementations, the method can include causing the at least one of the LLM or the VLM to map each target of the plurality of targets to at least one corresponding item of the plurality of items based at least on the plurality of parameters. In some implementations, the plurality of parameters comprise one or more of a content size constraint, a restriction on characters, or an optional guideline. In some implementations, the method can include using the at least one of the LLM or the VLM to parse one or more policy documents to extract the plurality of parameters. In some implementations, the method can include assigning a first target of the plurality of targets to a first item of the plurality of items and assigning a second target of the plurality of targets to a second item of the plurality of items, based at least on the plurality of parameters. In some implementations, the one or more processors can perform a validation of the content relative to the plurality of parameters, and output an error responsive to detecting noncompliance of the content relative to the plurality of parameters.

At least one other aspect relates to a non-transitory computer-readable medium comprising machine-readable instructions that when executed by one or more processors, cause the one or more processors to perform operations. The operations can include selecting a destination channel for synchronization of content to the destination channel. The operations can include detecting a plurality of parameters of the destination channel, the plurality of parameters comprising at least one of a natural language description or a machine-readable description, for at least one of a structure, a syntax, or a format for the content. The operations can include causing at least one of a large language model (LLM) or a vision language model (VLM) to generate content comprising a plurality of items regarding an object, based at least on a plurality of targets selected for the object and the plurality of parameters, each content item corresponding to one or more respective parameters of the plurality of parameters. The operations can include transmitting a synchronization signal to the destination channel, the synchronization signal comprising instructions to update a data structure regarding the object according to the content.

In some implementations, the operations can include using the at least one of the LLM or the VLM to validate the content against the plurality of parameters. In some implementations, the operations can include causing the transmission of the synchronization signal based at least on the validation of the content. In some implementations, the operations can include causing the at least one of the LLM or the VLM to map each target of the plurality of targets to at least one corresponding item of the plurality of items based at least on the plurality of parameters. In some implementations, the plurality of parameters comprise one or more of a content size constraint, a restriction on characters, or an optional guideline. In some implementations, the operations can include using the at least one of the LLM or the VLM to parse one or more policy documents to extract the plurality of parameters. In some implementations, the operations can include assigning a first target of the plurality of targets to a first item of the plurality of items and assigning a second target of the plurality of targets to a second item of the plurality of items, based at least on the plurality of parameters.

At least one other aspect relates to a system. The system can include one or more processors. The system can monitor one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object. The system can compute, based at least on the one or more feedback elements, an updated performance metric regarding completion of the one or more electronic interactions. The system can detect a content modification condition based at least on the updated performance metric. The system can generate, responsive to detecting the content modification condition, an update of one or more targets of the plurality of targets, to obtain a set of updated targets. The system can cause at least one of a large language model (LLM) or a vision language model (VLM) to generate an update of the content representation using the set of updated targets. The system can synchronize the update of the content representation to the electronic resource.

In some implementations, the system can detect the content modification condition based at least on monitoring the one or more feedback elements over a predetermined duration and comparing the updated performance metric to a prior value for the performance metric detected over a same amount of time as the predetermined duration. In some implementations, the system can compute the updated performance metric to correspond to completion of one or more electronic interactions including a site visit to a site of the electronic resource that provides the content representation or an interaction with a transaction user interface element provided for the object. In some implementations, the system can map the one or more feedback elements to one or more corresponding targets of the plurality of targets, based at least on one or more identifiers of the corresponding targets indicated for the one or more feedback elements. In some implementations, the system can select the one or more corresponding targets for updating according to the mapping. In some implementations, the system can perform a weighted attribution of the updated performance metric to one or more targets of the plurality of targets to select the one or more targets for modification. In some implementations, the system can trigger evaluation of the content modification condition based on at least one of a command or expiration of a monitoring timer. In some implementations, the initial value is greater than a threshold for the performance metric for a given target of the plurality of targets, and the system can exclude the given target from the update of the content representation responsive to an updated value according to the one or more feedback elements for the given target being less than the threshold.

At least one other aspect relates to a method. The method can be performed, for example, by one or more processors coupled to non-transitory memory. The method can include monitoring one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object. The method can include computing, based at least on the one or more feedback elements, an updated performance metric regarding completion of the one or more electronic interactions. The method can include detecting a content modification condition based at least on the updated performance metric. The method can include generating, responsive to detecting the content modification condition, an update of one or more targets of the plurality of targets, to obtain a set of updated targets. The method can include causing at least one of a large language model (LLM) or a vision language model (VLM) to generate an update of the content representation using the set of updated targets. The method can include synchronizing the update of the content representation to the electronic resource.

In some implementations, the method can include detecting the content modification condition based at least on monitoring the one or more feedback elements over a predetermined duration and comparing the updated performance metric to a prior value for the performance metric detected over a same amount of time as the predetermined duration. In some implementations, the method can include computing the updated performance metric to correspond to completion of one or more electronic interactions including a site visit to a site of the electronic resource that provides the content representation or an interaction with a transaction user interface element provided for the object. In some implementations, the method can include mapping the one or more feedback elements to one or more corresponding targets of the plurality of targets, based at least on one or more identifiers of the corresponding targets indicated for the one or more feedback elements. In some implementations, the method can include selecting the one or more corresponding targets for updating according to the mapping. In some implementations, the method can include performing a weighted attribution of the updated performance metric to one or more targets of the plurality of targets to select the one or more targets for modification. In some implementations, the method can include triggering evaluation of the content modification condition based on at least one of a command or expiration of a monitoring timer. In some implementations, the initial value is greater than a threshold for the performance metric for a given target of the plurality of targets, and the method can include excluding the given target from the update of the content representation responsive to an updated value according to the one or more feedback elements for the given target being less than the threshold.

At least one other aspect relates to a non-transitory computer-readable medium comprising machine-readable instructions that when executed by one or more processors, cause the one or more processors to perform operations. The operations can include monitoring one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object. The operations can include computing, based at least on the one or more feedback elements, an updated performance metric regarding completion of the one or more electronic interactions. The operations can include detecting a content modification condition based at least on the updated performance metric. The operations can include generating, responsive to detecting the content modification condition, an update of one or more targets of the plurality of targets, to obtain a set of updated targets. The operations can include causing at least one of a large language model (LLM) or a vision language model (VLM) to generate an update of the content representation using the set of updated targets. The operations can include synchronizing the update of the content representation to the electronic resource.

In some implementations, the operations can include detecting the content modification condition based at least on monitoring the one or more feedback elements over a predetermined duration and comparing the updated performance metric to a prior value for the performance metric detected over a same amount of time as the predetermined duration. In some implementations, the operations can include computing the updated performance metric to correspond to completion of one or more electronic interactions including a site visit to a site of the electronic resource that provides the content representation or an interaction with a transaction user interface element provided for the object. In some implementations, the operations can include mapping the one or more feedback elements to one or more corresponding targets of the plurality of targets, based at least on one or more identifiers of the corresponding targets indicated for the one or more feedback elements. In some implementations, the operations can include selecting the one or more corresponding targets for updating according to the mapping. In some implementations, the operations can include performing a weighted attribution of the updated performance metric to one or more targets of the plurality of targets to select the one or more targets for modification. In some implementations, the operations can include triggering evaluation of the content modification condition based on at least one of a command or expiration of a monitoring timer.

At least one other aspect relates to a system. The system can include one or more processors. The system can present a graphical user interface that includes at least a first portion and a second portion, the first portion comprising a sorted list of targets regarding performance for completion of one or more events regarding at least one object, and the second portion comprising a content representation regarding the at least one object and an indication of one or more updates to the content representation corresponding to one or more targets of the sorted list of targets. The system can modify the content representation according to a user input received via a first graphical user element associated with the content representation. The system can transmit a synchronization signal to a destination channel responsive to receiving a synchronize command via a second graphical user element associated with the content representation, the synchronization signal comprising the content representation.

In some implementations, the system can receive the user input as a natural language text or audio instruction to modify the content representation. In some implementations, the system can generate the sorted list of targets based at least on a score of relevance of each target of the sorted list of targets to the at least one object. In some implementations, the system can present a first subset of the sorted list of targets, having a score for the performance greater than a threshold, using a first graphical characteristic, and present a second subset of the sorted list of targets, having a score of the performance less than the threshold, using a second graphical characteristic. In some implementations, the system can pre-populate the indication of the one or more updates in the second portion responsive to activation of the graphical user interface, and confirm the one or more updates for inclusion in the content representation responsive to the user input. In some implementations, the system can present the second portion in a format corresponding to presentation of the content representation on a remote device. In some implementations, the system can receive the user input as a modification to a format, content, or syntax of the one or more targets.

At least one other aspect relates to a method. The method can be performed, for example, by one or more processors coupled to non-transitory memory. The method can include presenting a graphical user interface that includes at least a first portion and a second portion, the first portion comprising a sorted list of targets regarding performance for completion of one or more events regarding at least one object, and the second portion comprising a content representation regarding the at least one object and an indication of one or more updates to the content representation corresponding to one or more targets of the sorted list of targets. The method can include modifying the content representation according to a user input received via a first graphical user element associated with the content representation. The method can include transmitting a synchronization signal to a destination channel responsive to receiving a synchronize command via a second graphical user element associated with the content representation, the synchronization signal comprising the content representation.

In some implementations, the method can include receiving the user input as a natural language text or audio instruction to modify the content representation. In some implementations, the method can include generating the sorted list of targets based at least on a score of relevance of each target of the sorted list of targets to the at least one object. In some implementations, the method can include presenting a first subset of the sorted list of targets, having a score for the performance greater than a threshold, using a first graphical characteristic, and presenting a second subset of the sorted list of targets, having a score of the performance less than the threshold, using a second graphical characteristic. In some implementations, the method can include pre-populating the indication of the one or more updates in the second portion responsive to activation of the graphical user interface, and confirming the one or more updates for inclusion in the content representation responsive to the user input. In some implementations, the method can include presenting the second portion in a format corresponding to presentation of the content representation on a remote device. In some implementations, the method can include receiving the user input as a modification to a format, content, or syntax of the one or more targets.

At least one other aspect relates to a non-transitory computer-readable medium comprising machine-readable instructions that when executed by one or more processors, cause the one or more processors to perform operations. The operations can include presenting a graphical user interface that includes at least a first portion and a second portion, the first portion comprising a sorted list of targets regarding performance for completion of one or more events regarding at least one object, and the second portion comprising a content representation regarding the at least one object and an indication of one or more updates to the content representation corresponding to one or more targets of the sorted list of targets. The operations can include modifying the content representation according to a user input received via a first graphical user element associated with the content representation. The operations can include transmitting a synchronization signal to a destination channel responsive to receiving a synchronize command via a second graphical user element associated with the content representation, the synchronization signal comprising the content representation.

In some implementations, the operations can include receiving the user input as a natural language text or audio instruction to modify the content representation. In some implementations, the operations can include generating the sorted list of targets based at least on a score of relevance of each target of the sorted list of targets to the at least one object. In some implementations, the operations can include presenting a first subset of the sorted list of targets, having a score for the performance greater than a threshold, using a first graphical characteristic, and presenting a second subset of the sorted list of targets, having a score of the performance less than the threshold, using a second graphical characteristic. In some implementations, the operations can include pre-populating the indication of the one or more updates in the second portion responsive to activation of the graphical user interface, and confirming the one or more updates for inclusion in the content representation responsive to the user input. In some implementations, the operations can include presenting the second portion in a format corresponding to presentation of the content representation on a remote device.

At least one other aspect relates to a system. The system can include one or more processors. The system can deploy a plurality of instances of content representations regarding an object, each instance of the plurality of instances generated from one or more targets of a plurality of targets, a first instance of the plurality of instances comprising a first variant of the one or more targets, a second instance of the plurality of instances comprising a second variant of the one or more targets, the second variant different from the first variant. The system can sample one or more performance metrics regarding each of the first instance and the second instance. The system can detect, based at least on the sampling, that the one or more performance metrics for at least one of the first instance or the second instance are less than a performance threshold. The system can cause operation of at least one of a large language model (LLM) or a vision language model (VLM) to modify incorporation of the one or more targets of at least one of the first instance or the second instance, based at least on the one or more performance metrics being less than the performance threshold. The system can trigger a re-synchronization of the at least one of the first instance or the second instance based at least on the modification of the incorporation of the one or more targets.

In some implementations, the system can iteratively, until a performance improvement condition is satisfied, perform the sampling, detection, and operation of the at least one of the LLM or the VLM. In some implementations, the system can generate the first variant and the second variant to be different in syntax and to have less than a threshold difference in content as indicated by an embedding of the first variant and an embedding of the second variant. In some implementations, the system can determine the one or more performance metrics according to event data detected from an electronic resource on which the first instance and the second instance are deployed. In some implementations, the system can deploy the plurality of instances according to a schedule. In some implementations, the system can normalize the one or more performance metrics according to an overall electronic communication metric traffic associated with one or more destination channels on which the first instance and the second instance are deployed. In some implementations, the system can present a dashboard comprising the one or more performance metrics for the first instance and the second instance.

At least one other aspect relates to a method. The method can be performed, for example, by one or more processors coupled to non-transitory memory. The method can include deploying a plurality of instances of content representations regarding an object, each instance of the plurality of instances generated from one or more targets of a plurality of targets, a first instance of the plurality of instances comprising a first variant of the one or more targets, a second instance of the plurality of instances comprising a second variant of the one or more targets, the second variant different from the first variant. The method can include sampling one or more performance metrics regarding each of the first instance and the second instance. The method can include detecting, based at least on the sampling, that the one or more performance metrics for at least one of the first instance or the second instance are less than a performance threshold. The method can include causing operation of at least one of a large language model (LLM) or a vision language model (VLM) to modify incorporation of the one or more targets of at least one of the first instance or the second instance, based at least on the one or more performance metrics being less than the performance threshold. The method can include triggering a re-synchronization of the at least one of the first instance or the second instance based at least on the modification of the incorporation of the one or more targets.

In some implementations, the method can include iteratively, until a performance improvement condition is satisfied, performing the sampling, detection, and operation of the at least one of the LLM or the VLM. In some implementations, the method can include generating the first variant and the second variant to be different in syntax and to have less than a threshold difference in content as indicated by an embedding of the first variant and an embedding of the second variant. In some implementations, the method can include determining the one or more performance metrics according to event data detected from an electronic resource on which the first instance and the second instance are deployed. In some implementations, the method can include deploying the plurality of instances according to a schedule. In some implementations, the method can include normalizing the one or more performance metrics according to an overall electronic communication metric traffic associated with one or more destination channels on which the first instance and the second instance are deployed. In some implementations, the method can include presenting a dashboard comprising the one or more performance metrics for the first instance and the second instance.

At least one other aspect relates to a non-transitory computer-readable medium comprising machine-readable instructions that when executed by one or more processors, cause the one or more processors to perform operations. The operations can include deploying a plurality of instances of content representations regarding an object, each instance of the plurality of instances generated from one or more targets of a plurality of targets, a first instance of the plurality of instances comprising a first variant of the one or more targets, a second instance of the plurality of instances comprising a second variant of the one or more targets, the second variant different from the first variant. The operations can include sampling one or more performance metrics regarding each of the first instance and the second instance. The operations can include detecting, based at least on the sampling, that the one or more performance metrics for at least one of the first instance or the second instance are less than a performance threshold. The operations can include causing operation of at least one of a large language model (LLM) or a vision language model (VLM) to modify incorporation of the one or more targets of at least one of the first instance or the second instance, based at least on the one or more performance metrics being less than the performance threshold. The operations can include triggering a re-synchronization of the at least one of the first instance or the second instance based at least on the modification of the incorporation of the one or more targets.

In some implementations, the operations can include iteratively, until a performance improvement condition is satisfied, performing the sampling, detection, and operation of the at least one of the LLM or the VLM. In some implementations, the operations can include generating the first variant and the second variant to be different in syntax and to have less than a threshold difference in content as indicated by an embedding of the first variant and an embedding of the second variant. In some implementations, the operations can include determining the one or more performance metrics according to event data detected from an electronic resource on which the first instance and the second instance are deployed. In some implementations, the operations can include deploying the plurality of instances according to a schedule. In some implementations, the operations can include normalizing the one or more performance metrics according to an overall electronic communication metric traffic associated with one or more destination channels on which the first instance and the second instance are deployed.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example of a dynamic content generation system.

FIG. 2 is a flow diagram of an example of a method of dynamic content generation using generative machine learning models.

FIG. 3 is an illustration of an example of a graphical user interface to provide dynamically generated content according to selected targets.

FIG. 4 is a flow diagram of an example of a method of dynamic content generation using generative machine learning models.

FIG. 5 is a flow diagram of an example of a method of scoring-based dynamic content generation using generative machine learning models.

FIG. 6 is a flow diagram of an example of a method of performance-based dynamic content generation.

FIG. 7 is a flow diagram of an example of a method of performance-based content synchronization.

FIG. 8 is a flow diagram of an example of a method of performance monitoring-based content generation.

FIG. 9 is a flow diagram of an example of a method of dynamic content generation.

FIG. 10 is a flow diagram of an example of a method of performance-based content adaptation.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Online channels that present content to users can include, for example and without limitation, web-based applications, online marketplaces, and mobile applications. Such content can include text, image, and/or video content. For example, content can be provided for an online listing regarding an object, such as a product, and can include text describing the product, images of the product, and videos of use of the product.

It can be challenging to generate high performing content, and to scale generation of content over multiple channels and multiple products in a catalog. For example, natural language processing (NLP) and/or natural language generation (NLG) systems may be used to output text for content based on input indicating information to include for the content, such as to obviate the need for manual research and content creation. However, such systems may lack the ability to generate text that meets criteria such as syntactical variation or other characteristics of natural, engaging language. In addition, channels can have strict, detailed, and/or subtle content requirements for many distinct aspects of content to be presented such as for title, bullet points, descriptions, and backend keywords. Conventional content generation can be time-intensive and error-prone, and can lead to non-complaint listings, lower visibility in search results, and suboptimal performance. Rejected listings can require additional resources to correct, and can require hard-coded changes to rules or policies of the systems used to generate the content. In some instances such scaling challenges can be exacerbated by variations amongst and/or dynamic changes to the algorithms that online channels use to prioritize listings or return listings in response to queries for listings; for example, the policies or algorithms that electronic channels execute to prioritize or return listings can be opaque to or abstracted to the entities that provide information for listings, such as that a transparent function is not available for mapping content to corresponding performance. The search space of keywords and other semantic and/or visual information that can be included in listings is significantly larger than the available space (e.g., screen space; text, image, and/or video space available via graphical user interfaces on mobile or web applications; constraints from electronic channels on the amount of information that can be provided and/or presented via electronic listings) for presenting content, such that brute force keyword generation and/or does not allow for effective performance. Some conventional systems rely on predefined keyword lists, but such lists may lack clear signal attribution from performance to keywords.

Given various such technical deficiencies in conventional approaches to content performance, it is challenging to generate content that can achieve one or more performance criteria for use of the content. Performance criteria can relate to completion of events relating to the listings that include the content. For example, this can include completion of an electronic event, such as a period of time in which a user interface of a device of a user is directed to or focused on the listing, a click-through of a link of the listing, adding the product to an electronic cart, or completing an electronic purchase of the product. Such events can include events related to engagement with the content, such as periods of time in which images or video are viewed, or in which icons associated with the content (e.g., like buttons, reshare buttons, etc.) are interacted with. As noted above, it can be challenging to effectively predict characteristics of content that can achieve such performance criteria.

Systems and methods in accordance with the present disclosure can facilitate dynamic generation of content that can more effectively achieve performance criteria, such as to increase engagement with content and/or listings, as well as to increase the likelihood of event completion, such as to increase the likelihood of electronic purchase of products. For example, targets can be detected, ranked, and/or selected according to data that relates to expected performance. Such data can include, for example, ad sales, past sales or revenue information, context or seasonality information, characteristics of audiences to which to provide the listings, or various combinations thereof. The targets can include, for example and without limitation, semantic and/or visual descriptors (e.g., characteristics, keywords, classifications, categories, metadata) of the product, including any one or more text, audio, speech, image, and/or video characteristics. The targets can be represented in any one or more of natural language, numerical, structured or unstructured data, encodings, or latent space or vector space (e.g., as embeddings) data. As such, the system can identify targets that relate to performance, and that can provide a semantic representation of performance. In some implementations, the system can rank and/or filter candidate targets to select a subset of targets to use for content generation.

The system can provide input including the identified targets to one or more artificial intelligence (AI) models and/or generative AI models, such as one or more machine learning model-based content generators (for example and without limitation, language models, large language models, vision language models, diffusion models, multi-modal models) that can process text, image, and/or video inputs to generate the content to include text, image, and/or video outputs representative of the targets. As such, this can allow scalable, rapid generation of content that can enhance listing (e.g., product detail page) performance. In some implementations, image and/or video content can include image information of the product as well as of one or more users for the product. For example, a realistic or virtual avatar of a person can be generated, such as to provide a speaker to present natural language outputs regarding the product and/or demonstrate use of the product. By using the performance-related input data to generate targets, which are in turn used to generate the content (e.g., using the generative AI model), the system can rapidly generate more engaging and performant content. For example, systems and methods in accordance with the present disclosure can perform online content optimization, including to optimize product catalog listings on e-commerce channels by leveraging generative AI models. Moreover, the system can flexibly optimize content customized to any one or more channels, including but not limited to by performing target selection and/or content generation according to criteria for any one or more channels.

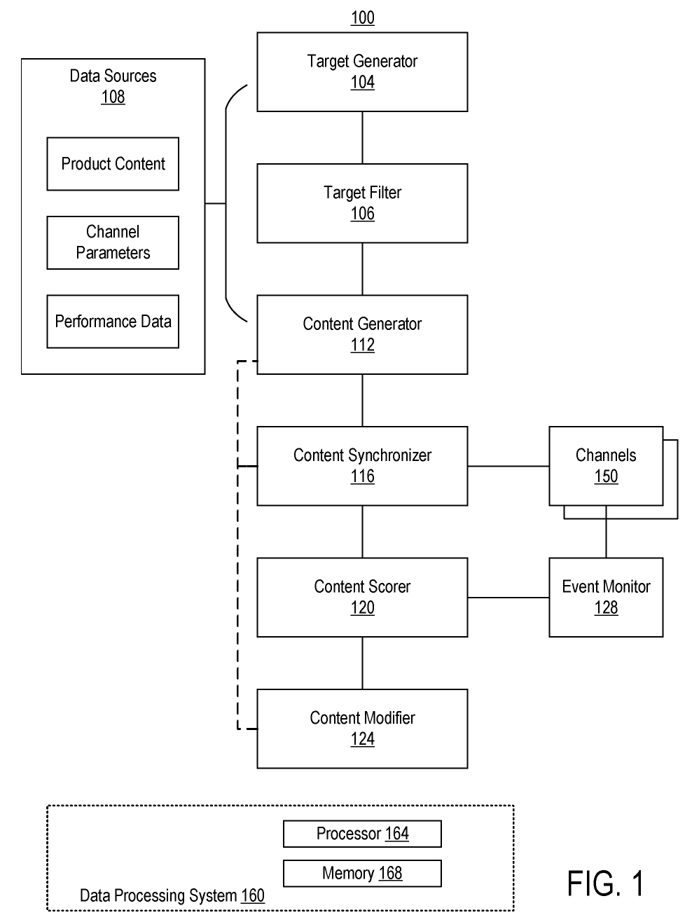

FIG. 1 depicts an example of a system 100 (e.g., a content generation system, a content generation pipeline). The system 100 can perform any of various operations described herein, including to facilitate catalog optimization and/or multichannel catalog optimization, including to automatically detect conditions for recommending content generation or updating, and to scale content generation across a catalog of many products and/or across multiple channels. The system 100 can include one or more functions, algorithms, rules, heuristics, machine learning models, or various combinations thereof to perform one or more operations described herein. The system 100 can include one or more models that are structured as agents, such as to have modular or discrete input, processing, and/or output (e.g., including automated outputs and/or capability of causing actions to occur using generated outputs) capabilities. The system 100 can include and/or be deployed on a local machine, server, client device, web application, mobile application, on-premises system, cloud system, or any one or more combinations thereof.

The system 100 can generate content that satisfies or is expected to have high or optimized performance for product listings. The performance of a product listing can include completion of electronic events and/or likelihood of completion of electronic events relating to (e.g., attributable to) the product listing. For example, the completion of the event can correspond to at least one of a purchase event for the product, a conversion event of an interaction to a downstream event in a sequence of events, a navigation event from an electronic advertisement to a listing for the product, or an engagement event with the product listing (e.g. and without limitation, clickthrough, interaction with an image or video, interaction with an interface element of an image or video, such as a like, reshare, or subscribe button).

The system 100 can be or include at least one computing platform (e.g., data processing system 160). As depicted in FIG. 1, the data processing system 160 can include one or more processors 164, and one or more memory (e.g., memory devices) 168, which can be coupled with any of various communications electronics. The processor 164 can be a general purpose or specific purpose processor, an application specific integrated circuit (ASIC), one or more field programmable gate arrays (FPGAs), a group of processing components, or other suitable processing components. The processor 164 may be configured to execute computer code or instructions stored in memory (e.g., fuzzy logic, etc.) or received from other computer readable media (e.g., CDROM, network storage, a remote server, etc.) to perform one or more of the processes described herein. The memory 168 may include one or more data storage devices (e.g., memory units, memory devices, computer-readable storage media, etc.) configured to store data, computer code, executable instructions, or other forms of computer-readable information. The memory 168 may include random access memory (RAM), read-only memory (ROM), hard drive storage, temporary storage, non-volatile memory, flash memory, optical memory, or any other suitable memory for storing software objects and/or computer instructions. The processor 164 can be implemented as a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof. The memory 168 may include database components, object code components, script components, or any other type of information structure for supporting the various activities and information structures described in the present disclosure. The memory 168 can include various modules (e.g., circuits, engines) for completing processes described herein. The system 100 can include any one or more communications electronics (e.g., wired or wireless reception and/or transmission circuitry; communications busses; etc.), and can include any one or more user interface devices (e.g., displays, microphones, keyboards, mouse devices, touch input devices, etc.) to facilitate communication with the data processing system 160 and/or one or more components thereof. The data processing system 160 can be implemented in any of various computing platforms or architectures, including but not limited to any of various client-server architectures, distributed architectures, or agentic architectures.

The system 100 can include at least one target generator 104. The target generator 104 can perform operations such as generating, ranking, and/or selecting one or more targets regarding an object, such as a product. The targets can include, for example and without limitation, semantic and/or visual descriptors (e.g., characteristics, keywords, classifications, categories, metadata) of the product, including any one or more text, audio, speech, image, and/or video characteristics. The targets can be represented in any one or more of natural language, numerical, structured or unstructured data, encodings, or latent space or vector space (e.g., as embeddings) data.

The target generator 104 can use ad performance and/or customer search data to surface high-impact targets to incorporate into the content for listings. The target generator 104 can be used to more effectively generate targets that correspond with higher performance, such as by generating candidate targets according to performance-related factors such as organic and paid ad campaign data, and/or search query relevance metrics, and ranking and/or selecting targets to be used in content according to relevance scores determined for a given product.

The target generator 104 can select targets that represent semantic information regarding products, where such semantic information (e.g., information and/or data having selected subject matter and/or meaning) is expected to have high performance. This can allow for more efficient content generation while mitigating compute resources directed towards generation of low performance content, including to facilitate carrying through useful semantic information from any of various input modalities to text, images, speech, audio, and/or video of content generated by content generator 112. For example, the target generator 104 can allow for more efficient use of compute resources for operation of the content generator 112, such as by requiring fewer inference operations of the content generator 112 to complete a task; in some implementations, by generating targets with higher performance and/or expected performance, the system 100 can operate a feedback loop (e.g., as described with respect to content modifier 124) with fewer iterations of operation of the content generator 112 to achieve a given and/or threshold level of performance, and thus can reduce overall compute resource usage to achieve the given level of performance.

For example, the target generator 104 can obtain and/or retrieve a plurality of targets (e.g., candidate targets) regarding the product(s). In some implementations, the target generator 104 retrieves the targets from one or more predetermined lists of targets, such as from services that provide targets or previously generated or recommended targets. The target generator 104 can retrieve targets associated with search traffic for products.

The target generator 104 can generate at least one target of the plurality of targets. This may be performed, for example, for a new product that has not had a listing published or had sufficient listing data captured. For example, the target generator 104 can generate targets according to product information, search information, or combinations thereof. In some instances, existing targets or the information used to generate targets may be sufficiently targeted to the product to allow for reliable mapping of targets to products, which may result in a likelihood of low-performing targets being identified. Target generation can help address cold start issues in which a new product is to be listed for which existing and/or historical performance data is unavailable or is not sufficient for reliable target retrieval.

In some implementations, the target generator 104 retrieves or generates targets relating to a target parameter for the product listing. The target parameter can include or be based on an audience or language for the product listing. The target parameter can include or be based on dynamic information, such as seasonality information (e.g., to allow for content initially generated for a first season, e.g., spring, to be modified for a second season, e.g., fall) and/or demand information (e.g., trend data relating to characteristics of products that may be useful to highlight in a given period of time). The target generator 104 can receive one or more target parameters as input to a target generation operation, such as by providing the target parameters alongside product information and/or performance data to a machine learning model or rule-based function that generates candidate targets conditioned on the target parameters, where the target parameters can constrain or bias the generated targets toward a specified audience, language, season, and/or demand characteristic. The target generator 104 can periodically re-execute the target generation operation in response to detecting a change in one or more target parameters, such as a transition from a first seasonality value to a second seasonality value or an update to demand information, and can replace or supplement previously generated targets with targets generated according to the updated target parameters. This can allow the target generator 104 to more dynamically and/or responsively generate targets having a greater likelihood of achieving performance metrics.

In some implementations, the system 100 can classify and/or group candidate targets according to a source from which each candidate target was obtained and/or a category associated with each candidate target. For example, the target generator 104 can determine, for each candidate target, whether the candidate target originated from a search term report, an advertisement campaign report, a keyword suggestion service, or existing product listing content, and can assign a source classification to the candidate target accordingly. The target generator 104 can classify candidate targets according to a category such as a product family, a campaign type, a channel identifier, or a language identifier, where the category can correspond to a grouping under which performance metrics for the candidate target are to be normalized. The target generator 104 can assign a tag to each candidate target based on the classification determined for the candidate target, where the tag can indicate the source type, the target type, or the category grouping associated with the candidate target. For example, the tag can be a tag identifier stored in a data structure in association with the candidate target, and the tag identifier can correspond to the classification group such that downstream operations of the target generator 104 can retrieve and use the tag identifier to apply group-specific normalization parameters and/or weighting functions during ranking. In some implementations, the target generator 104 can assign different tags to candidate targets obtained from different sources, such that candidate targets from a search term report receive a first tag and candidate targets from a keyword suggestion service receive a second tag, and target filter 106 can normalize performance metrics within each tag grouping separately before computing a composite rank score across tag groupings. The tags can be assigned prior to scoring, filtering, and/or ranking operations performed by the target generator 104 and/or the target filter 106, such that the tags are available for use during subsequent target selection operations. For example, the target filter 106 can rank and/or filter candidate targets within respective groups associated with the tags.

Referring further to FIG. 1, the system 100 can include or be coupled with at least one target filter 106. The target filter 106 can perform operations such as scoring candidate targets according to one or more metrics associated with performance of the candidate targets; filtering, from the candidate targets, selected targets for further processing by the system 100 (e.g., using the content generator 112); and/or ranking candidate targets.

The target filter 106 can rank the plurality of targets. Ranking the targets, e.g., according to one or more criteria associated with performance or expected performance, can facilitate generation of content that has greater performance, such as to focus inclusion of targets on higher performing targets while avoiding inclusion of lower performing targets. For example, product listings may have limited space (e.g., image or video size and/or character or word limits), which can necessitate selecting only a subset of targets for content generation. The target filter 106 can receive, as inputs to a ranking operation, performance data associated with each candidate target, such as advertisement sales data, search volume data, and/or relevance scores determined by the target generator 104, and can normalize the performance data within one or more groupings (e.g., per product, per target type, and/or per tag grouping assigned at classification) to generate comparable scores across candidate targets. The target filter 106 can apply a weighting function to the normalized scores, such as to compute a composite rank score for each candidate target using a weighted combination of the normalized relevance scores, the normalized advertisement sales data, and/or the normalized search volume data. The target filter 106 can order the candidate targets according to the composite rank scores, and can select a subset of the candidate targets for content generation based at least on a threshold applied to the composite rank scores and/or a predetermined subset number (e.g., a top-N number of candidate targets).

In some implementations, the target filter 106 assigns a relevance, e.g., relevance score, to one or more targets of the plurality of targets. For example, the target filter 106 can determine a semantic similarity between a candidate target and a product. The target filter 106 can determine embeddings of targets and products (e.g., product information) in one or more modalities, e.g., text, image, and/or video modalities, such as to map targets and product information into a shared vector space to allow for evaluating semantic similarity across modalities. In some implementations, the target filter 106 uses one or more embedding models to determine the embeddings, such as one or more bidirectional encoder representations from transformers (BERT), sentence transformer, or language models (e.g., LLMs). The target filter 106 can include a pre-trained embedding model and/or can include a trained and/or fine-tuned embedding model (e.g., using labeled datasets of targets, products, and indications of whether the targets are relevant or not relevant to corresponding products).

The embedding model for the target filter 106 can be selected according to one or more model performance metrics, such as accuracy, precision, recall, and/or F1 score, such as to identify an embedding model that has sufficient performance metrics given test data for how the embedding model correctly labels embeddings (e.g., determines that example targets are relevant or not relevant). In some implementations, the system 100 determines a discrimination threshold according to relevance scores determined for targets. The target filter 106 can evaluate a plurality of candidate embedding models against a labeled dataset to select an embedding model for relevance scoring. The labeled dataset can include positive examples of product-target pairs that are known to be relevant and negative examples of product-target pairs that are known to be irrelevant or that are randomly paired. The target filter 106 can generate, for each candidate embedding model, embeddings of the positive examples and the negative examples, and can compute similarity scores between the product embeddings and the target embeddings within each example pair. The target filter 106 can determine, for each candidate embedding model, one or more discrimination metrics based on the similarity scores, such as receiver operating characteristic (ROC) curves, area under the curve (AUC) values, accuracy, precision, recall, and/or F1 score, where the discrimination metrics can indicate how effectively the candidate embedding model separates the positive examples from the negative examples. For example, the target filter 106 can compare the discrimination metrics across the plurality of candidate embedding models and can select the candidate embedding model that provides a target tradeoff between false positive rate and false negative rate for production use. In some implementations, the target filter 106 can determine a cost-weighted objective that assigns different weights to false positives and false negatives according to operational goals, and can select the candidate embedding model that minimizes the cost-weighted objective over the labeled dataset. By performing one or more such operations, the target filter 106 can facilitate more efficient usage of computing resources, such as by facilitating fewer generative model inference operations to achieve a given performance level (in addition to generating higher performance targets).

For example, the target filter 106 can determine a target embedding of each candidate target. The target filter 106 can determine the target embedding by providing the candidate target as input to the selected embedding model, which can generate a vector representation of the candidate target in a vector space. For example, the target filter 106 can process the text of the candidate target (e.g., a keyword, a phrase, a multi-term expression, etc.) through the embedding model to produce a fixed-dimensional numerical vector that encodes the semantic content of the candidate target. In some implementations, the target filter 106 can determine target embeddings for candidate targets that include non-textual characteristics, such as audio, speech, image, and/or video characteristics, by providing the non-textual characteristics as input to the embedding model or to a modality-specific embedding model that maps the non-textual characteristics into the same or a compatible vector space as text-based target embeddings. The target filter 106 can store each target embedding in association with the corresponding candidate target in a data structure, such that the target embeddings are accessible for subsequent comparison with a product embedding during relevance scoring operations.

The target filter 106 can determine a product embedding of the product based on product information such as text, image, and/or video information regarding the product. The target filter 106 can generate the product embedding by providing the product information as input to the selected embedding model, which can generate a vector representation of the product in the same vector space as the target embeddings generated for the candidate targets. In some implementations, the target filter 106 can generate the product embedding from multimodal product information, such as by providing a text and/or narrative description of the product, an image of the product, and/or a video of the product to the embedding model or to a modality-specific embedding model that maps each modality into the shared vector space. The target filter 106 can store the product embedding in association with the product in a data structure, such that the product embedding is accessible for subsequent comparison with the target embeddings during relevance scoring operations performed by the target filter 106.

The target filter 106 can determine the relevance of each candidate target based at least on a comparison of the target embedding with the product embedding, such as by performing a cosine similarity operation on the target embedding and the product embedding to generate a numerical relevance score. The target filter 106 can compare the relevance score to one or more discrimination thresholds to classify the relevance of the candidate target, such as to classify the candidate target as relevant or not relevant, or to classify into one of three or more classes (e.g., highly relevant, relevant, not relevant, etc.). For example, the target filter 106 can retain candidate targets having a relevance score that satisfies the discrimination threshold and can discard candidate targets having a relevance score below the discrimination threshold. In some implementations, the target filter 106 can rank the retained candidate targets according to the relevance scores, such as to assign a higher ranking to candidate targets having higher relevance scores relative to candidate targets having lower relevance scores.

The target filter 106 can determine the one or more discrimination thresholds based at least on the product-target pairs, such as according to a distribution of relevance scores computed over the labeled dataset of product-target pairs. For example, the target filter 106 can compute relevance scores for each positive example and each negative example in the labeled dataset, and can determine a threshold value at which the separation between relevant and irrelevant product-target pairs satisfies a discrimination performance (e.g., target value for discrimination performance). In some implementations, the target filter 106 can determine the discrimination threshold by optimizing a cost-weighted objective function that assigns a first weight to false positives and a second weight to false negatives, where the first weight and the second weight can be set according to operational goals such as prioritizing avoidance of irrelevant target recommendations over retention of marginally relevant targets. The target filter 106 can evaluate multiple candidate threshold values along a receiver operating characteristic (ROC) curve generated from the relevance scores for the labeled dataset, and can select the candidate threshold value that minimizes the cost-weighted objective function. In some implementations, the target filter 106 can determine language-specific and/or category-specific discrimination thresholds, such that a first discrimination threshold applies to candidate targets associated with a first language or a first product category and a second discrimination threshold applies to candidate targets associated with a second language or a second product category, where the language-specific and/or category-specific thresholds can account for variations in the distribution of relevance scores across different languages and/or product categories.

The target filter 106 can rank the targets based at least on the relevance scores of the targets. For example, the target filter 106 can assign a higher ranking to targets having relatively higher relevance scores, and vice versa. The target generator 104 can determine the rankings as discrete values. For example, the rankings can be numerical values on a given scale (e.g., zero to one; one to one hundred). The target filter 106 can determine the rankings as classes or categories (e.g., high, medium, low).

The target filter 106 can rank (and/or filter) the targets based at least on performance data. For example, the target filter 106 can rank targets based on one or more of ad sales or search volume associated with targets. In some implementations, the target filter 106 can rank one or more candidate targets in the absence of performance data, such as when a product has not accumulated sufficient advertisement sales data or search volume data to compute performance-based ranking scores. For example, the target filter 106 can rank the one or more candidate targets based at least on a relevance score determined from a comparison of a target embedding and a product embedding, on a frequency of the candidate target in search term reports, and/or on a recency of the candidate target relative to other candidate targets, such that the target filter 106 can generate a ranking for candidate targets associated with a new product for which event-completion performance data is unavailable or insufficient. The target filter 106 can transition from the relevance-based or frequency-based ranking to the performance-based ranking as performance data accrues for the product, such as by increasing a weight assigned to performance data relative to a weight assigned to relevance scores in a composite ranking function over successive ranking operations.

In some implementations, the target filter 106 normalizes and/or applies a weighting function to ranking of targets, e.g., to assign weights to relevance, ad sales, and search volume data. The system 100 can update the weights, e.g., according to information from content scorer 120 and/or content modifier 124, to facilitate continuous optimization of content over time.

The target filter 106 can obtain performance data regarding one or more candidate targets of the plurality of candidate targets, where the performance data can include advertisement sales data, search volume data, conversion rate data, clickthrough rate data, and/or engagement event data associated with the candidate targets for the product. The target filter 106 can filter the plurality of candidate targets based at least on the performance data and a weight for the performance data, where the weight can be selected according to a level of aggregation of the performance data relative to the product. For example, performance data that is aggregated at a product-specific level (e.g., advertisement sales data attributed directly to the product) can receive a first weight, and performance data that is aggregated at a broader level relative to the product (e.g., search volume data aggregated across a product family, a campaign type, and/or a channel rather than attributed to an individual product) can receive a second weight that is lower than the first weight, such that the target filter 106 can assign greater influence to performance data having a finer granularity of attribution to the product during the filtering operation. In some implementations, the target filter 106 can determine the level of aggregation for each type of performance data by comparing a scope identifier associated with the performance data to a product identifier for the product, where a match between the scope identifier and the product identifier can indicate product-specific aggregation and a mismatch can indicate a broader aggregation level. The target filter 106 can apply the selected weights to the performance data during computation of a composite filtering score for each candidate target, and can retain candidate targets having a composite filtering score that satisfies a threshold value while discarding candidate targets having a composite filtering score below the threshold value.

The target filter 106 can selectively provide selected targets to be used for content generation, such as to select a subset of selected targets for content generation. The subset can include at least one of a subset number (e.g., top ten) or a subset satisfying a composite ranking score (e.g., determined according to any one or more of relevance and/or performance data). The target filter 106 can constrain the subset according to one or more destination parameters, such as a listing field size, an image or video size, and/or a character or word limit associated with a destination channel, such that the number of selected targets does not exceed a capacity of the content to be generated for the destination channel. In some implementations, the target filter 106 can output the subset of selected targets to the content generator 112 for use in generating content representative of the product, where the output can include the selected targets together with associated ranking scores, relevance scores, and/or tag identifiers determined during the ranking and filtering operations performed by the target filter 106.

Referring further to FIG. 1, the system 100 can include or be coupled with one or more data sources 108. The data sources 108 can include information relating to products, performance, channels, or various combinations thereof. The data sources 108 can be maintained by the system 100 or an entity of the system 100, or can be separate from the system 100. The system 100 can update the one or more data sources 108, such as based on data generated by the content scorer 120, content modifier 124, and/or event monitor 128.

The one or more data sources 108 can include product data. The product data can include any one or more text, speech, audio, image, and/or video information relating to products. The product data can include metadata regarding products and/or catalogs of products, such as based on metadata maintained by one or more systems of record regarding products and/or catalogs of products. As described herein, the target generator 104 and/or content generator 112, for example and without limitation, can use metadata for target selection and/or content generation, e.g., based on relating metadata to performance data, to allow for higher performance content generation. In some implementations, the product data includes data representing a first state, e.g., an initial state, of the content. The initial state can include a current or previous listing for the product. For example, the product data can include an initial state of the text description of the product, an image relating to the product, or a video relating to the product. In some implementations, the product data includes templates for product listings and/or content, such as templates provided by a user of the system 100. The product data can include data relating to any one or more products across a network of available data to the system 100, e.g., relating to multiple products, catalogs of products, and/or entities in any of various channels or sectors, as well as panel data, e.g., data associated with event completion, customer engagement with electronic resources, and/or longitudinal data monitoring. The system 100 (e.g., using any one or more components including but not limited to machine learning models or other algorithms) can process the product data to detect characteristics of products and/or content regarding products associated with performance information, such as perform an econometric and/or heterogeneity analysis of such data to relate product data with performance. This can allow for more effective performance detection and mapping to features of products and/or catalogs, such as to take advantage of network effects and data scale to more effectively generate targets (e.g., using target generator 104).

One or more data sources 108 can include performance data. The performance data can include, for example, metrics relating to performance of products or listings for products in one or more channels 150. The performance data can include advertisement sales data. The performance data can include search volume data. The performance data can be associated with products and/or targets for products.

The one or more data sources 108 can include channel parameters. The channel parameters can indicate characteristics, requirements, and/or criteria for generation of content for any one or more channels (e.g., channels 150). For example, the channel parameters can include parameters specific to a given channel 150 (as there may be distinct variations in some requirements for each channel 150) or applicable to multiple channels 150.

For example, the channel parameters can indicate a structure or syntax for the content. The channel parameters can indicate, for example for text of content, content size constraints, character limits, formatting, disallowed terms or characters, and/or target restrictions. In some implementations, the data sources 108 store or retrieve the channel parameters from a policy document; as described herein, the natural language processing capabilities of the content generator 112 can allow the content generator 112 to operate on the policy document directly, e.g., without requiring a separate manual or NLP operation to extract parameters from the policy document. In some implementations, the channel parameters include aspects such as a field (e.g., section of a listing for which a parameter applies) as well as a level of requirement of parameters (e.g., hard requirements that must be satisfied; best practices that may be useful but not required to comply with channel requirements or avoid rejection; optional guidelines).

The channel parameters for structure can include parameters relating to generation of image and/or video content. For example, the channel parameters can indicate target locations in an image for portions of content to be provided, such as to have a brand banner in a first target location, a product name in a second target location, and an image of the product in a third target location.

The channel parameters can include structured or unstructured indications of criteria for the content, including checklists and/or specifications that may be in a natural language format. For example, this can facilitate more rapid modifications to the manner in which the content generator 112 generates content, such as to rely on the usefulness of generative AI models in operating on natural language format inputs. The criteria for content can be used (e.g., by content generator 112 and/or content scorer 120) to audit the generated content, such as to implement an audit agent that reviews content according to a checklist. Channel parameters may have variations across different channels 150; as described herein, by providing channel parameters for any given channel 150 to the content generator 112, the content generator 112 can more effectively optimize content for each channel 150. The content generator 112 can use the channel parameters to assign targets to content items, such as to assign a first target to a title content item, and a second target to a description content item.

Referring further to FIG. 1, in some implementations, the target generator 104 determines targets using data from data sources 108. For example, the target generator 104 can retrieve data from any one or more data sources 108, including but not limited to predetermined product listing descriptions, to use to select targets.

In some implementations, the target filter 106 can filter out any targets according to filtration criteria, such as filter criteria relating to the channel parameters or filter criteria associated with a source (e.g., source entity) or brand of the product. For example, the target filter 106 can filter out brand or product names that may not be used on a given channel or may not relate to a product of a user of the system 100. This can allow the system 100 to operate with negative keywords, for example.

Referring further to FIG. 1, the system 100 can include at least one content generator 112. The content generator 112 can include one or more functions, algorithms, rules, heuristics, machine learning models, or various combinations thereof to perform one or more operations described herein, including generation of content to be used for an online listing for a product. For example, the content generator 112 can be or include a generative AI model that generates content representative of the product using one or more targets, such as using the selected targets.

The content generator 112 can include one or more machine learning models, neural networks, encoder-decoder models, transformer models (e.g., generative pre-trained transformer (GPT) models), language models, small language models (SLMs), large language models (LLMs), multimodal models (e.g., models that can receive as input and/or generate as output data of one or more modalities such as text, image, speech, audio, and/or video), diffusion models, latent diffusion models, generative adversarial networks (GANs), vision-language models (VLMs), or various combinations thereof. The content generator 112 can include a plurality of models arranged in a pipeline. One or more models of the content generator 112 can be structured as agents. The system 100 can implement any of various retrieval techniques for the content generator 112, including using data from the one or more data sources 108. For example, the content generator 112 can include a transformer-based architecture that uses self-attention mechanisms to process input sequences and generate output sequences, where the self-attention mechanisms can allow the content generator 112 to attend to different positions within an input sequence when producing each element of an output sequence. The content generator 112 can include an encoder component that processes an input representation into a latent representation and a decoder component that generates an output sequence from the latent representation, where the encoder component and the decoder component can each include one or more layers of multi-head attention and feed-forward sub-layers. In some implementations, the content generator 112 can include a decoder-only architecture, such as an autoregressive language model, that generates output tokens sequentially by conditioning each output token on previously generated tokens and on one or more input representations including the selected targets and channel parameters. The content generator 112 can include convolutional neural network architectures for image-based content generation, recurrent neural network architectures for sequential content generation, or combinations of convolutional, recurrent, and transformer-based architectures arranged in a multi-stage pipeline where a first model in the pipeline generates an intermediate representation and a second model in the pipeline refines or extends the intermediate representation into a final content output.

The content generator 112 can receive, as input, data from the target generator 104, the target filter 106, and/or the one or more data sources 108, including the selected targets, channel parameters for a destination channel, product information such as text descriptions, images, audio, and/or video of the product, and metadata regarding the product. The content generator 112 can receive the selected targets as a structured or unstructured set of semantic descriptors, where each selected target can be accompanied by associated ranking scores, relevance scores, and/or tag identifiers determined during target selection and filtering operations. The content generator 112 can receive channel parameters as input indicating structure, syntax, character limits, formatting constraints, disallowed terms or characters, and field-specific constraints for the destination channel, and can condition the generation of content on the channel parameters such that the generated content conforms to the constraints of the destination channel. The content generator 112 can generate, as output, content in one or more modalities including text, image, audio, speech, and/or video content representative of the product and representative of the selected targets. For example, the content generator 112 can generate text outputs including titles, bullet point descriptions, product descriptions, and backend keyword fields, and can generate image outputs including product images, infographic images, and lifestyle images, and can generate video outputs including product demonstration videos and spoken audio relating to the product. The content generator 112 can generate the output content as a complete listing or as a modification to previous content, where the modification can include insertion, replacement, or reorganization of portions of the previous content to incorporate the selected targets.

One or more models of the content generator 112 can be trained, fine-tuned, or otherwise configured using training data that includes pairs of input representations and corresponding target output representations. For example, the training data can include input representations comprising product information, selected targets, and channel parameters, and corresponding target output representations comprising content that has been generated or curated for product listings on one or more channels. During a training operation, the content generator 112 can process each input representation through the model architecture to generate a predicted output representation, and can compute a loss value by comparing the predicted output representation to the corresponding target output representation using a loss function such as a cross-entropy loss for text generation or a perceptual loss for image generation. The content generator 112 can update the weights of the model during backpropagation by computing gradients of the loss value with respect to the weights of each layer of the model, and can propagate the gradients from an output layer through intermediate layers to an input layer of the model. The content generator 112 can apply the computed gradients to the weights using an optimization algorithm, such as stochastic gradient descent, adaptive moment estimation, or other gradient-based optimization techniques, to adjust the weights in a direction that reduces the loss value for subsequent training iterations. In some implementations, the content generator 112 can be fine-tuned using training data that includes examples of content that achieved high performance metrics on destination channels, such that the weight updates during fine-tuning can condition the content generator 112 to generate content having characteristics associated with higher event-completion performance. The content generator 112 can be further configured through prompt engineering or in-context learning, where examples of generated content can be provided as part of an input prompt to the content generator 112 to guide the generation of content toward a target style, structure, and format without modifying the underlying model weights.

One or more models of the content generator 112 can be configured (e.g., trained, fine-tuned, updated, have prompt engineering performed, have in-context learning performed) to perform operations including generation of outputs according to data from data sources 108 and/or from the target generator 104. For example, the content generator 112 can be provided examples of generated content to configure the content generator 112 to generate similar output as the examples. In some implementations, the content generator 112 includes one or more machine learning models that can improve the image and/or video quality of the content. For example and without limitation, the content generator 112 can include one or more convolution neural network (CNN), deep learning, superresolution or inpainting models that can improve quality characteristics of the content such as resolution, brightness, and/or contrast.

The content generator 112 can generate the content according to at least one of a target from the target generator 104 and/or target filter 106, and data from one or more data sources 108. For example, where a previous content (e.g., stored as product content) is available, the content generator 112 can generate the content as an update of the previous content that includes or represents the target, from the target generator 104, such as to include one or more selected targets from the target generator 104. This can allow the content generator 112 to improve the expected performance of the content. The content generator 112 can generate the content to represent one or more targets, even if not in an exact same form as the target itself; for example, the content generator 112, e.g., using the natural language generation capabilities of language models, can flexibly generate the content to include variations in grammar for the manner in which the target is represented for the content (e.g., modifying tense, order of terms for multi-term targets, translation of targets from a given language or data format into natural language, etc.). The content generator 112 can use metadata from data sources 108 to generate the content, such as based on associations between metadata and performance data.

The content generator 112 can generate content using one or more templates and/or predetermined structures obtained from the one or more data sources 108. For example, the content generator 112 can receive a template that defines a predetermined arrangement of content fields for a product listing, where the template can specify a title field, one or more bullet point fields, a description field, one or more backend keyword fields, and/or one or more image or video placement fields, and the content generator 112 can populate each content field of the template with generated content that incorporates the selected targets. In some implementations, the content generator 112 can receive a predetermined structure, from the one or more data sources 108, that indicates an ordering and/or hierarchy of content sections for a destination channel, and the content generator 112 can generate content that conforms to the ordering and/or hierarchy indicated by the predetermined structure. For example, the predetermined structure can indicate that a title section precedes a bullet point section, that the bullet point section precedes a description section, and that each section has a respective character limit, and the content generator 112 can allocate the selected targets across the sections according to the respective character limits and the ranking scores associated with the selected targets, such as by assigning higher-ranked targets to the title section and distributing remaining targets across the bullet point section and the description section. In some implementations, the content generator 112 can receive predetermined content from the one or more , such as an initial state of a product listing or previously generated content for the product, and the content generator 112 can generate updated content by modifying the predetermined content to incorporate the selected targets. For example, the content generator 112 can identify portions of the predetermined content that do not include or do not represent one or more of the selected targets, and the content generator 112 can replace, supplement, and/or reorganize the identified portions to include representations of the selected targets while retaining portions of the predetermined content that already represent one or more of the selected targets. The content generator 112 can receive the templates and/or predetermined structures as part of an input provided alongside the selected targets and channel parameters, such that the content generator 112 can condition the generation of content on the template layout, the channel parameters, and the selected targets concurrently during a single generation operation.

In some implementations, the content generator 112 generates the content based at least on one or more channel parameters. As noted above, this can allow the content generator 112 to effectively customize content to be expected to achieve performance criteria for any given channel 150. For example, the natural language processing and generation capabilities of the content generator 112 can be used to more effectively use the channel parameters as input or template information for generation of the content. This can allow the content generator 112 to automatically generate content that is compliant with the channel 150. By generating content that is compliant (e.g., based at least on using the channel parameters as input to the content generation), the content generator 112 can mitigate failed content uploads or synchronization actions, such as to reduce noncompliance and/or content rejection; this can allow for reduced compute and/or network demands, such as by avoiding wasted API calls to the destination channels 150 that may otherwise result from noncompliant uploads.

In some implementations, the content generator 112, for a given product, generates at least a first instance of content for a first channel 150 according to one or more channel parameters for the first channel and a second instance of content for a second channel 150 according to one or more channel parameters for the second channel, such that the first and second instances of content may have descriptive similarities (e.g., may be have content representative of the targets for the product) while having variations in structure, feature inclusion, and/or grammar (e.g., to account for variations in criteria for each channel 150 as represented by the channel parameters). In some implementations, the content generator 112 operates a unique algorithm to generate content for any given channel 150, such as based on any one or more of the data used to generate content and/or any machine learning training, prompt engineering, and/or workflow features that can allow the content generator 112 to customize unique content for each channel 150.

The content generator 112 can generate content that includes text, e.g., unstructured, natural language, and/or structured text. In some implementations, the text can be structured to be in a title and bullet point description format. The content generator 112 can generate the text, using the targets, to enhance title, bullets, description, and/or backend fields with high performance targets targeted to channels 150.

The content generator 112 can generate content that includes one or more images. For example, the content generator 112 can generate images that can be included in a product listing page, such as to represent one or more of the product, a user of the product, and text information relating to targets for the product. In some implementations, the content generator 112 generates images (and/or videos) according to input images and/or videos regarding the product; the content generator 112 may include detection and/or classification models that can process input images to extract image and semantic information (e.g., to describe an initial product image or listing image), which the generative model of the content generator 112 can use to more effectively generate content, including without necessarily requiring detailed descriptions of products or manually generated descriptions of existing images or listings to facilitate further content generation.

The content generator 112 can generate content that includes one or more videos. For example, the content generator 112 can apply the targets as input to a diffusion model or other video generation model to generate videos that represent the product, such as to perform generation guided by the selected targets. The content generator 112 can generate video content that incorporates the selected targets as conditioning inputs to a video generation model, such as a diffusion model and/or a latent diffusion model, where the conditioning inputs can constrain the latent space sampling of the video generation model to regions corresponding to the semantic content of the selected targets. By conditioning the video generation model (and/or image generation and/or text generation models, as discussed above) on the selected targets, the content generator 112 can reduce the number of denoising iterations and/or inference operations that the video generation model executes to converge on a video output that represents the product in accordance with the performance-related semantic information encoded in the selected targets. For example, the selected targets can narrow a search space of candidate video frames and/or candidate scene compositions that the video generation model evaluates during generation, such that the video generation model expends fewer compute cycles generating and discarding intermediate video representations that do not correspond to the selected targets. The content generator 112 can provide the selected targets as text-based prompts, embedding vectors, and/or structured metadata to the video generation model, and the video generation model can use the selected targets to bias attention weights and/or cross-attention layers toward semantic features associated with the selected targets during each forward pass of the generation operation.

The content generator 112 can generate image and/or video content to include a representation of a user (e.g., human user) of the product. For example, the representation can include a realistic (e.g., corresponding to a real person) or virtual (e.g., corresponding to a generated or animated person) user representation. In some implementations, such as for video generation, the content generator 112 can drive the content generation to include the representation speaking audio relating to the product, such as based at least on the selected targets. This can allow for scalable generation of more engaging content. For example, The content generator 112 can generate video content that includes the user representation by providing the selected targets and product information as input to a video generation model, which can generate a sequence of video frames depicting the user representation in association with the product. The content generator 112 can generate audio content based at least on the selected targets, such as by providing the selected targets to a text-to-speech model that generates spoken audio describing characteristics of the product corresponding to the selected targets. The content generator 112 can synchronize the generated audio content with the video frames depicting the user representation, such that the user representation appears to speak the generated audio within the video content. In some implementations, the content generator 112 can generate the user representation by processing one or more input images and/or videos of a person through a generative model, such as a generative adversarial network and/or a diffusion model, to generate a realistic or virtual depiction of the person that can be composited into the video content alongside the product.

The content generator 112 can generate the content output to be populated for one or more content items. The content items can include fields and/or user interface elements, images, videos, graphics, etc. The content generator 112 can generate the content output for each content item based at least on one or more presentation constraints associated with the content items, where the presentation constraints can include a character limit, a word limit, a pixel limit, and/or a dimensional constraint for presentation of the content items via at least one interface of a destination channels 150. For example, a title content item can have a first character limit (e.g., 150 characters, 200 characters, etc.) that differs from a second character limit associated with a bullet point content item (e.g., 500 characters, 1000 characters, etc.), and the content generator 112 can condition the generation of the content output for each content item on the respective character limit such that the generated text does not exceed the character limit for the content item. In some implementations, an image content item can have a pixel limit that constrains a maximum pixel dimension (e.g., a width in pixels, a height in pixels, and/or a total pixel count) for an image to be presented via the at least one interface, and the content generator 112 can generate the image content output to satisfy the pixel limit by constraining an output resolution and/or an output aspect ratio of the generated image to values that do not exceed the pixel limit. The content generator 112 can receive the character limits and/or the pixel limits as part of the channel parameters retrieved from the one or more data sources 108, where each channel parameter can specify a respective presentation constraint for a corresponding content item field of the destination channels 150. The content generator 112 can allocate the selected targets across the plurality of content items according to the presentation constraints, such as by assigning a first subset of the selected targets to a title content item having a first character limit and a second subset of the selected targets to a description content item having a second character limit that is greater than the first character limit, such that a greater number of selected targets can be represented in content items having larger presentation constraints. In some implementations, the content generator 112 can truncate and/or reformulate a portion of a content output that would otherwise exceed a character limit or a pixel limit for a given content item, such as by generating an abbreviated representation of a selected target within the content output that satisfies the character limit while preserving the semantic content of the selected target.

As depicted in FIG. 1, the system 100 can include or be coupled with one or more destination channels 150. The destination channels 150 can include one or more electronic systems and/or electronic resources that can store data regarding and/or present the content, including to store listings that can include the content or receive the content, such as to be synchronized to incorporate the content. The destination channels 150 can include servers, online marketplaces, websites, web applications, mobile applications, image presentation channels, video presentation channels, social media websites or applications, or various combinations thereof. For example, the destination channels 150 can be provided and/or deployed by one or more electronic resources, such as one or more electronic systems that can store data regarding and/or present content, including servers, application programming interfaces (APIs), web applications, mobile applications, online marketplaces, websites, or various combinations thereof.

The channels 150 can provide one or more interfaces on which the content and/or listings are presented to downstream users, such as graphical user interfaces of web applications, mobile applications, and/or marketplace storefronts. The downstream users can perform one or more actions via the interfaces of the channels 150, such as search queries that return listings in a search result set, navigation actions to access product listing pages, and/or engagement actions relating to the listings including clickthrough interactions, image or video viewing, and/or electronic purchase events. In some implementations, the system 100 and/or the one or more data sources 108 can store associations (e.g., tags and/or identifiers) mapping each destination channel 150 to its respective channel parameter(s).

In some implementations, the content generator 112 generates, for a given product (e.g., based at least on targets for the given product), content for a plurality of destination channels 150. For example, the content generator 112 can use the targets and channel parameters to generate channel-specific content, such as to customize content (e.g., from at least one or more common targets) for each channels 150. The content generator 112 can receive, for each destination channels 150, a respective set of channel parameters from the one or more data sources 108, where each respective set of channel parameters can indicate channel-specific structure, syntax, character limits, formatting constraints, disallowed terms or characters, and/or field-specific constraints for the corresponding destination channels 150. The content generator 112 can generate a first instance of content for a first destination channels 150 by providing the selected targets together with the channel parameters for the first destination channels 150 as input to a generative model, and can generate a second instance of content for a second destination channels 150 by providing the selected targets together with the channel parameters for the second destination channels 150 as input to the generative model, such that the first instance and the second instance share descriptive content representative of the common selected targets while differing in structure, field allocation, grammar, and/or formatting to satisfy the respective channel parameters for each destination channels 150. For example, the first instance of content can include a title having a first character limit and a first set of bullet point descriptions conforming to a first formatting constraint for the first destination channels 150, and the second instance of content can include a title having a second character limit and a second set of bullet point descriptions conforming to a second formatting constraint for the second destination channels 150, where the first character limit and the second character limit can differ based on the respective channel parameters. In some implementations, the content generator 112 can execute a separate generation operation for each destination channels 150, where each generation operation can condition the generative model on the channel parameters for the respective destination channels 150 to generate content that conforms to the constraints of that destination channels 150 without requiring post-generation reformatting or manual adjustment of the generated content.

Referring further to FIG. 1, the system 100 can include at least one content synchronizer 116. The content synchronizer 116 can include one or be coupled with one or more network interfaces to communicate with channels 150. The content synchronizer 116 can transmit the content generated by the content generator 112 to one or more channels 150, such as based on receiving an instruction to update product listings on the one or more channels 150. For example, the content synchronizer 116 can receive an input indicating instructions to synchronize the content to the channels 150.

The content synchronizer 116 can synchronize content and/or changes to content to channels 150, e.g., with the click of button, and can track status of updates to make sure the content goes live. The content synchronizer 116 can transmit the content to each of the one or more channels 150 via respective application programming interfaces (APIs) and/or network protocols associated with each destination channels 150, such as by formatting the content according to channel-specific data schemas and transmitting the formatted content as one or more API requests directed to the destination channels 150. The content synchronizer 116 can maintain a synchronization state record for each transmission, where the synchronization state record can store an identifier of the destination channels 150, a timestamp of the transmission, and/or a status value indicating whether the transmission has been received, processed, and/or published by the destination channels 150. In some implementations, the content synchronizer 116 can monitor, e.g., periodically monitor, status or error information regarding product listings, and can present an indication of the status. The content synchronizer 116 can uniquely monitor status and manage optimization for any given channel 150, e.g., according to the channel parameters of each channel 150 and/or unique performance metrics for each channel 150, allowing for more scalable long-term optimization of content.

In some implementations, the system 100 can receive a single input command to perform target selection and content synchronization across a plurality of objects, such as a plurality of products in a catalog. For example, the system 100 can select, in response to the single input command, targets for each of the plurality of objects that satisfy a threshold level of performance, where the threshold level of performance can correspond to a composite ranking score, a relevance score, and/or a performance metric value (e.g., advertisement sales data, search volume data, clickthrough rate data, etc.) that each selected target satisfies for the respective object. The content generator 112 can generate respective updated content representations for each of the plurality of objects using the selected targets for each object, and the content synchronizer 116 can synchronize the respective updated content representations for each of the plurality of objects to one or more destination channels 150 in response to the single input command without requiring a separate synchronization command for each object. The single input command can be received at a user interface element (e.g., a button, a selectable icon, etc.) of the interface 300, and can cause the system 100 to execute the target selection, content generation, and content synchronization operations for the plurality of objects as a batch operation, such that the content synchronizer 116 transmits the respective updated content representations for each of the plurality of objects to the one or more destination channels 150 without intervening user input between transmission of each respective updated content representation.

The content synchronizer 116 can poll the destination channels 150 at one or more intervals following the transmission to retrieve updated status information, such as a confirmation that the content has been published on the destination channels 150 or an indication that the transmission has been queued for processing by the destination channels 150. In some implementations, the content synchronizer 116 can update the status value in the synchronization state record from a pending state to a published state upon receiving a confirmation response from the destination channels 150 indicating that the content has been published, or can update the status value to a failed state upon receiving a rejection response and/or upon expiration of a timeout period without receiving a confirmation response.

For example, the content synchronizer 116 can set the status value to a first value (e.g., "pending") upon initiating the transmission, can set the status value to a second value (e.g., "live") upon receiving the confirmation response from the destination channels 150, and can set the status value to a third value (e.g., "failed") upon receiving the rejection response or upon detecting that the timeout period has elapsed. The content synchronizer 116 can present the status value at a user interface, such as by rendering a visual indicator associated with each destination channels 150 that reflects the current synchronization state, including an indication of successful synchronization and/or an indication of a synchronization failure together with a description of the failure returned by the destination channels 150. The content synchronizer 116 can re-initiate the transmission to the destination channels 150 in response to a status value indicating a failed state, such as by generating a subsequent API request directed to the destination channels 150 and updating the synchronization state record to reflect the re-initiated transmission.

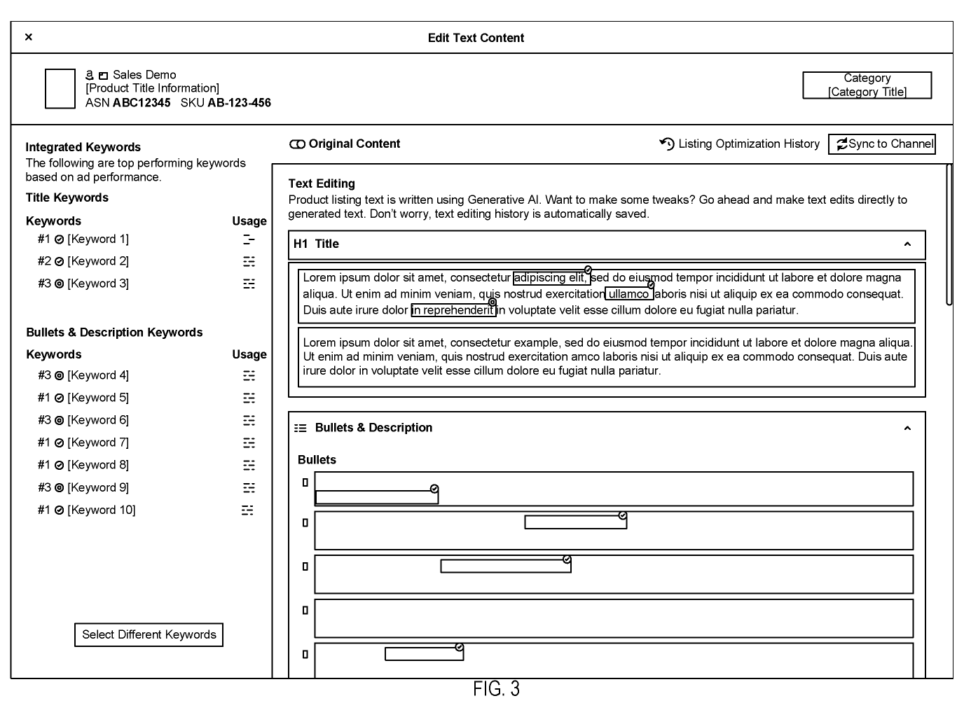

Referring further to FIG. 1, the content synchronizer 116 can present an interface (e.g., as depicted in FIG. 3) that can represent the content in one or more states, such as the initial state and the updated state. This can allow for more efficient content generation and editing. For example, the content synchronizer 116 can present (e.g., on a device of a user) a user interface that comprises each of a current state of the content representation and the updated content representation, in which the plurality of targets are provided with a modified graphical identifier relative to corresponding content of the current state. The content synchronizer 116 can present the user interface to indicate a current state of the content representation and a state of updating of the current state relative to the plurality of targets.

In some implementations, the content synchronizer 116 can present an interface for manual updating of the content. For example, the content synchronizer 116 can present the interface based at least on receiving a command for manual editing. The content synchronizer 116 can update the content on (e.g., synchronize the content to) the channels 150 based at least on receiving a command, at the interface, for synchronizing the content. In some implementations, the interface can present one or more graphical user interface icons to facilitate manual editing of the content, such as an edit icon that causes the interface to transition to an editable state for one or more content fields and/or a revert icon that causes the interface to restore a previous state of the content prior to manual editing. The content synchronizer 116 can receive a selection of the one or more graphical user interface icons and can modify the presentation of the content in the interface according to the selection, such as to present an editable text field for a title, a bullet point description, and/or a backend keyword field of the content.

In some implementations, the system 100 (e.g., using the content synchronizer 116) surfaces recommendations, e.g., open recommendations, to generate and/or update the content. For example, the content synchronizer 116 can monitor a description of the product and the performance data relating to the product to detect a content generation condition, such as to detect a condition in which the content does not include or does not properly include a target that may have greater performance than as provided in the content. The system 100 can present a recommendation to update the description to include one or more selected targets responsive to detecting the content generation condition.

Referring further to FIG. 1, the system 100 can include at least one content scorer 120. The content scorer 120 can determine a content score, e.g., one or more performance metrics associated with product listings on the channels 150. The content score can include, for example, performance metrics analogous to the data used for target ranking, such as ad sales, search volume, and/or event completion data. In some instances, it can be challenging to systematically evaluate the effectiveness of content optimization in product listings over predefined time intervals or in scalable analytics. By relating the content generated by the system 100 to performance metrics, the system 100 can facilitate systematic, scalable content performance analytics. The content scorer 120 can compute an updated performance metric for each of the first content and the second content, where the updated performance metric can correspond to completion of one or more electronic interactions associated with the content, such as a site visit to a site of an electronic resource that provides the content representation and/or an interaction with a transaction user interface element provided for the object (e.g., an add-to-cart button, a purchase button, a subscription button, etc.).

In some implementations, the system 100 (e.g., using the content scorer 120) can provide analytics and/or testing operations regarding content. For example, the system 100 can perform testing, such as A/B testing, such as to cause the content generator 112 to generate a first content for a first channel 150 or first segment of a channel 150, and to generate a second content for a second channel 150 or second segment of the channel 150. The system 100 can cause the content scorer 120 to monitor one or more metrics for the content on each of the first channel (or first segment) and second channel (or second segment). The system 100 can perform the monitoring over a test campaign period. The system 100 can provide an output indicative of the one or more metrics over the test campaign period. In some implementations, the system 100 presents a request to update the content to match the higher scoring content according to the test and/or automatically updates the content to match the higher scoring content. The system 100 can present analytics dashboards regarding the performance metrics, such as to provide rapid and/or actionable assessments of content performance, which can be used to for subsequent optimization decisions.

As depicted in FIG. 1, the system 100 can include at least one content modifier 124. The content modifier 124 can cause a modification (e.g., update) to the content according to the content score for the content. For example, the content modifier 124 can generate a modification to the content based at least on the performance metrics for the use of the content in the one or more channels 150. This can allow the system 100 to track listing performance post-optimization, which can providing insights into organic traffic, sales, and/or revenue impact. The content modifier 124 can be used to periodically and/or continuously (e.g., according to a schedule and/or regular intervals) re-evaluate listings, such as to provided updated content modification recommendations according to the performance metrics. For example, the content modifier 124 can cause the content synchronizer 116 and/or content generator 112 to update one or more aspects of content, such as to regenerate content according to rescoring of targets. For example, the content modifier 124 can cause the target generator 104 to periodically update the plurality of targets according to performance metrics determined by the content scorer 120 for the plurality of targets, and can cause the content generator 112 to refresh the content representation according to the updated plurality of targets. In some implementations, the content modifier 124 can cause an update to the content based at least on detecting a content generation condition. The content generation condition can include a determination that a performance metric for the content on a destination channels 150 has fallen below a threshold value for at least a predefined duration, such as a predefined number of consecutive evaluation periods and/or a predefined elapsed time window during which the performance metric remains below the threshold value. For example, the content scorer 120 can compute one or more performance metrics for the content at successive intervals, and the content modifier 124 can compare each computed performance metric to the threshold value and can increment a duration counter each time the performance metric falls below the threshold value. The content modifier 124 can determine that the content generation condition is satisfied when the duration counter satisfies the predefined duration, and can cause the target generator 104 to re-rank and/or re-select the plurality of targets and can cause the content generator 112 to regenerate the content according to the re-selected targets.

The content modifier 124 can map each feedback data element received by the event monitor 128 to one or more corresponding targets of the plurality of targets based at least on one or more target identifiers indicated in the feedback data element, where each target identifier can correspond to a target that was used to generate the content for which the feedback data element was received. The content modifier 124 can select the one or more corresponding targets for updating according to the mapping, such that the target generator 104 can re-rank and/or re-select the mapped targets based at least on the performance metrics associated with the feedback data elements mapped to the corresponding targets.

The content modifier 124 can perform a weighted attribution of the updated performance metric to one or more targets of the plurality of targets based at least on a mapping between each target and the one or more content items to which the target was assigned during content generation. For example, the content modifier 124 can assign a first attribution weight to a target mapped to a title content item and a second attribution weight to a target mapped to a description content item, where the first attribution weight and the second attribution weight can differ based on a relative contribution of each content item to the updated performance metric. The content modifier 124 can select the one or more targets for modification based at least on the weighted attribution, such that targets mapped to content items receiving a higher attribution weight relative to other content items can be prioritized for re-ranking and/or re-selection by the target generator 104. By performing weighted attribution, the content modifier 124 can facilitate convergence to steady-state and/or high performing targets in fewer target update cycles, which can reduce compute and/or network resource usage.

As depicted in FIG. 1, the system 100 can include at least one event monitor 128. The event monitor 128 can sample and/or request data, such as feedback data elements, regarding the content on one or more destination channels 150. For example, the event monitor 128 can transmit one or more data requests to each destination channels 150 at one or more intervals, such as periodic intervals and/or event-driven intervals, to retrieve data relating to electronic events corresponding to performance of the content on the destination channels 150. The electronic events can include engagement actions (e.g., a period of time in which a user interface of a device of a user is directed to or focused on a listing, an interaction with an image or video of the listing, an interaction with an interface element such as a like button or reshare button, etc.), navigation events (e.g., a clickthrough from an electronic advertisement to a listing page for the product), conversion events (e.g., adding the product to an electronic cart, completing an electronic purchase of the product, etc.), and/or search events (e.g., a query that returned the listing in a search result set on the destination channels 150). The event monitor 128 can receive event data from each destination channels 150 in response to the data requests, where the event data can include event identifiers, event timestamps, event types, and/or event counts associated with the content on the destination channels 150. The event monitor 128 can store the received event data in the one or more data sources 108, such as in association with a product identifier and/or a channel identifier corresponding to the destination channels 150 from which the event data was received. In some implementations, the event monitor 128 can receive event data from the destination channels 150 via callback notifications and/or webhook registrations, such that the destination channels 150 transmits event data to the event monitor 128 upon occurrence of an electronic event rather than in response to a polling request from the event monitor 128.

One or more components of the system 100 can use the event data from the event monitor 128 to perform downstream operations. For example, the content scorer 120 can retrieve the event data stored by the event monitor 128 in the one or more data sources 108 and can compute one or more performance metrics for the content based at least on the event data, such as engagement rate, clickthrough rate, conversion rate, and/or search impression volume, where each performance metric can be computed over a time window corresponding to a predefined evaluation period. The content scorer 120 can associate the computed performance metrics with a content identifier and/or a listing identifier for the product, such that the performance metrics are available for use by the content modifier 124 and/or the target generator 104 in subsequent content modification and/or target re-ranking operations. In some implementations, the target generator 104 and/or the target filter 106 can use the event data from the event monitor 128 to update performance data associated with candidate targets, such as by updating advertisement sales data, search volume data, and/or engagement event data for targets based on event data received from the destination channels 150 after the content has been synchronized. The content modifier 124 can use the performance metrics computed by the content scorer 120 to determine whether to cause a modification to the content, such as by comparing the performance metrics to one or more threshold values and causing the content generator 112 to regenerate the content and/or causing the target generator 104 to re-rank and/or re-select targets when a performance metric falls below a corresponding threshold value.

The content modifier 124 can detect the content modification condition based at least on monitoring one or more feedback data elements received by the event monitor 128 over a predetermined duration and comparing an updated performance metric computed from the one or more feedback data elements to a prior value for the performance metric detected over a same amount of time as the predetermined duration. For example, the content scorer 120 can compute a first value for a performance metric (e.g., clickthrough rate, conversion rate, engagement rate, search impression volume, etc.) based on feedback data elements received during a first time window having a length equal to the predetermined duration, and can compute a second value for the performance metric based on feedback data elements received during a second time window having a length equal to the predetermined duration and preceding the first time window. The content modifier 124 can compare the first value to the second value to determine whether a difference between the first value and the second value satisfies a threshold change magnitude, such as a percentage decrease or an absolute decrease that exceeds a predefined change threshold. In some implementations, the content modifier 124 can determine that the content modification condition is satisfied when the first value is less than the second value by at least the threshold change magnitude, and can cause the target generator 104 to re-rank and/or re-select the plurality of targets and can cause the content generator 112 to regenerate the content according to the re-selected targets in response to detecting the content modification condition. The content modifier 124 can trigger evaluation of the content modification condition based on at least one of a command or expiration of a monitoring timer.

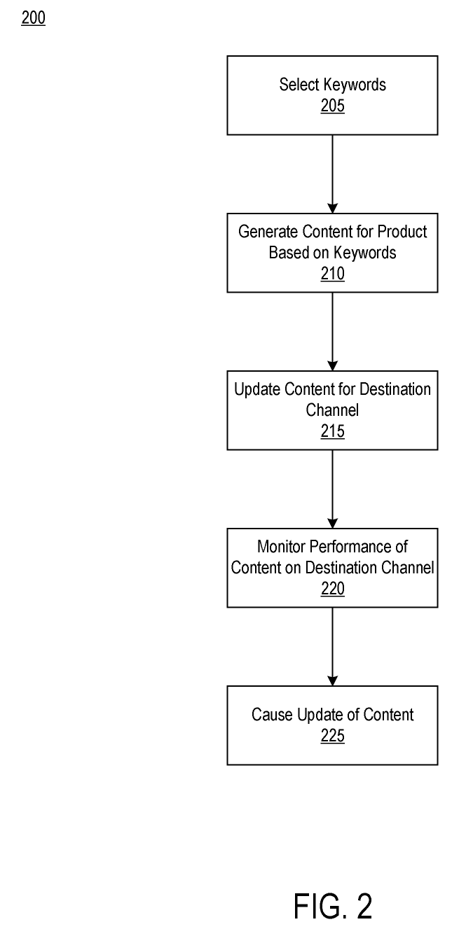

FIG. 2 depicts an example of a method 200 (e.g., a content optimization method). The method 200 can be performed using various systems and devices described herein, such as the system 100. The method 200 can be performed based on instructions to generate a product listing and/or update a product listing. One more operations of the method 200 can be executed based at least on monitoring of product performance data, such as in response to detecting an increase of a performance above a threshold or a decrease of a performance below a threshold. One or more operations of the method 200 can be performed based at least on dynamic conditions, such as seasonality, trends, or modifications in channel parameters that may be used to trigger updates to content.

At 205, a plurality of targets can be selected. The targets can represent semantic information to be used for generating content regarding a product, such as for a product listing. The targets can correspond to information previously used for the product listing. The targets can be extracted from information regarding the product, such as performance information, or predetermined text, speech, audio, image, and/or video information regarding the product. The targets can be retrieved from target recommendation systems for the product, e.g., in relation to search, ad, and/or sales metrics for performance of the product.

In some implementations, a relevance score is determined for the targets in relation to the product. For example, a semantic embedding of the target can be compared (e.g., using cosine similarity) with a semantic embedding of the product to determine whether the target is relevant to the product. In some implementations, irrelevant targets are discarded.

The targets can be ranked according to one or more factors. For example, the targets can be ranked based at least on relevance category (e.g., relevant or irrelevant), relevance score (e.g., a normalized score), or performance metrics (e.g., sales data, search volume data, ad data). In some implementations, the targets can be assigned to rank categories, such as high, medium, or low categories. Targets can be selected according to thresholds amongst rank, such as to select high ranking targets (or targets having a numerical ranking score greater than a threshold).

At 210, content for the product can be generated based at least on the selected targets. For example, content can be generated using one or more generative AI models (e.g., language models, image generation models, video generation models) as text, audio, speech, image, and/or video content. The content can be generated to focus on high performance information represented in any of various such modalities, e.g., by using the targets and/or performance information (which may be incorporated in the selection of the targets).

At 215, the content can be updated on one or more destination channels. For example, the content can be transmitted to a destination channel according to one or more formatting requirements and/or criteria for the destination channel. The content can be transmitted with instructions to update a listing for the product on the destination channel. The content can be published on the destination channel, e.g., as an image and/or video for an account for the product.

At 220, performance of the content on the destination channel can be monitored. For example, one or more performance metrics regarding the product listing can be monitored. The performance metrics can be analogous to the metrics used to generate or rank the targets. The performance metrics can include electronic event completion metrics, such as engagement metrics (e.g., time viewing listings; interaction with buttons for listings), clickthroughs, search volume, and/or purchase event metrics.

At 225, an update of the content can be caused. The update can be cause according to the monitored performance of the content. For example, the performance can be evaluated to determine whether to update at least one of one or more selected targets used to generate the content or to update the content. In some implementations, the performance metrics are used to update the target ranking, which can facilitate modifying or generating new targets to be used by the generative AI model to generate the content.

The update can be caused according to one or more dynamic metrics. For example, content can be updated according to trend data, seasonality data, or audience data, such a change in season, or a change in demand for a given type of product or feature of a product.

FIG. 3 depicts an example of an interface 300 that the system 100 can present to facilitate content generation, such as for managing content generation and updating/synchronizing to channels 150. For example, the interface 300 can include a first portion that presents the selected (e.g., highly ranked) targets, such as for identifying high performance targets for the product. The first portion can map the targets to fields or sections of the listing to be generated using the content, such as to a title section and to a bullet or description section. The interface 300 can include a second portion to present the generated content that includes the targets. The second portion can also present an initial state of the content, such as to facilitate efficient review and/or editing of updates made. The interface 300 can include a user interface element (e.g., button) to allow the user to cause an update of the listing on one or more channels 150, such as to synchronize the generated content to the channels 150. As depicted in FIG. 3, each target can be associated with a user interface element (e.g., selectable check box) that can control granular inclusion or exclusion of targets in content. The second portion can have a modified graphical identifier for the targets, such as to highlight or bold the targets within the content.

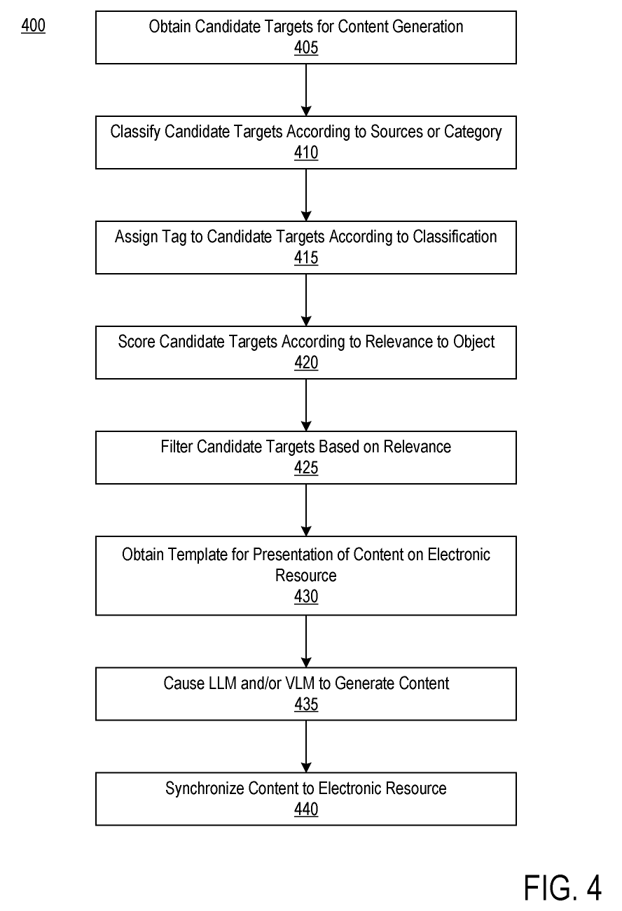

Referring now to FIG. 4, depicted is an illustrative flow diagram of a method 400, such as a method of dynamic content generation. The method 400 can be executed, performed, or otherwise carried out by any of the computing systems or devices described herein, including for example, the system 100. In brief overview of the method 400, the method 400 can include obtaining candidate targets for content generation (405), classifying candidate targets according to sources or category (410), assigning a tag to candidate targets according to classification (415), scoring candidate targets according to relevance to an object (420), filtering candidate targets based on relevance (425), obtaining a template for presentation of content on an electronic resource (430), causing an LLM and/or VLM to generate content (435), and synchronizing content to the electronic resource (440).

Referring to FIG. 4 in further detail, the method 400 can include obtaining candidate targets for content generation (405). A plurality of candidate targets regarding a product can be retrieved from one or more sources, where the candidate targets can include semantic and/or visual descriptors of the product such as characteristics, keywords, classifications, categories, and/or metadata. For example, the candidate targets can be retrieved from predetermined lists of targets, target recommendation services, previously generated or recommended targets, search term reports, keyword reports, and/or targets associated with search traffic for the product. The candidate targets can be retrieved from one or more data sources containing performance data such as advertisement sales data and search volume data, as well as product data including text, image, audio, and/or video information relating to the product. In some implementations, for a new product that has not had a listing published or has not had sufficient listing data captured, the candidate targets can be generated according to product information, search information, or combinations thereof to address cold-start situations in which existing performance data is unavailable or is not sufficient for reliable target retrieval. The generated candidate targets can be associated with available product data and/or partial performance metrics to facilitate subsequent ranking and filtering operations performed at later stages of the content generation pipeline.

The method 400 can include classifying candidate targets according to sources or category (410). Each candidate target can be classified according to the source from which the candidate target was obtained and/or according to a category associated with the candidate target, such as a source type corresponding to a search term report, a keyword suggestion service, and/or existing product listing data. The classification can be performed after obtaining the candidate targets at 405 and/pr prior to assigning tags at 415, such that downstream normalization and/or weighting operations can be performed within appropriate groupings defined by the classification. Each candidate target can be associated with a grouping identifier corresponding to the source, the product, a campaign type, a channel, and/or a language, where the grouping identifier can facilitate per-group normalization of performance metrics in subsequent scoring and ranking operations. In some implementations, the classification can include identification of targets associated with a different entity from the entity of the product, such as brand names and/or product names that may not be permitted on a given channel and/or that do not relate to the product, to facilitate subsequent filtering operations performed at later stages of the method 400.

The method 400 can include assigning a tag to candidate targets according to the classification (415). The tag can indicate a source type, a target type, and/or a category grouping for the candidate target. For example, the tag can indicate that a candidate target originated from a search term report, an advertisement campaign, a keyword suggestion service, and/or existing product listing content, and the tag can further indicate a grouping for normalization purposes such as a product family and/or a target type. In some implementations, the tags can be used to apply different normalization parameters and/or weighting functions to different groups of candidate targets during ranking, such as to normalize performance metrics within a grouping defined by the assigned tags.

The method 400 can include scoring candidate targets according to relevance to an object (420). A relevance score can be assigned to each candidate target by determining a semantic similarity between the candidate target and a product, where the relevance score can be based at least on a comparison of an embedding of each target with an embedding of text regarding the product. For example, a target embedding can be generated for the candidate target and a product embedding can be generated for information regarding the product, and a cosine similarity can be computed between the target embedding and the product embedding to produce a numerical relevance score. The embeddings can be determined using one or more embedding models, such as one or more bidirectional encoder representations from transformers (BERT), sentence transformer, or language models, where the embedding model can be selected according to one or more model performance metrics including accuracy, precision, recall, and/or F1 score based on test data for correct relevance labeling. In some implementations, the embedding model can be pre-trained, trained, or fine-tuned using labeled datasets of targets, products, and indications of whether the targets are relevant or not relevant to corresponding products, and targets and product information can be mapped into a shared vector space to allow for evaluating semantic similarity across modalities including text, image, and/or video modalities.

The method 400 can include filtering candidate targets based on relevance (425). The candidate targets can be filtered based on relevance after scoring at 420 and/or prior to obtaining the template at 430. The relevance score of each candidate target can be compared to one or more discrimination thresholds to classify each candidate target as relevant or not relevant, and candidate targets classified as not relevant can be discarded from further processing. The discrimination threshold can be determined globally, per language, or per category, and can be optimized according to a weighted cost function that balances false positives and false negatives according to operational goals, such that candidate targets having a relevance score below the discrimination threshold can be removed and remaining candidate targets can be retained and ranked by relevance score, performance data, or a combination thereof. The candidate targets can be further filtered based on entity-associated criteria, such as to remove brand names or product names associated with a different entity from the entity of the product, such that downstream content generation receives relevance-qualified targets from which entity-mismatched targets have been excluded. The remaining targets can be ranked based at least on relevance scores, performance data including ad sales or search volume, or a composite ranking score determined using normalization and a weighting function applied to relevance, ad sales, and search volume data.

The method 400 can include obtaining a template for presentation of content on an electronic resource (430). A template indicating one or more channel parameters for a destination channel can be obtained, where the channel parameters can indicate characteristics, formatting, structure, syntax, character limits, disallowed terms or characters, target restrictions, and/or field-specific constraints for generation of content for the destination channel. Parameters relating to generation of text content such as title, bullet points, descriptions, and backend fields, as well as parameters relating to image and/or video content such as target locations for product images, brand banners, and product name placement, can be included in the template. In some implementations, different templates can be obtained for different destination channels, where each template can have distinct variations in parameters such that content for each destination channel can be customized using common selected targets together with different channel-specific parameters.

The method 400 can include causing an LLM and/or VLM to generate content (435). The content can be generated using one or more language models (LLMs) and/or vision language models (VLMs) based at least on the selected targets and the template. The generated content can be provided as text, image, audio, speech, and/or video content, where text content can include title, bullet point descriptions, and backend fields incorporating the selected targets, and where image and/or video content can include representations of the product, one or more realistic or virtual user representations, and text information relating to the targets. The selected targets and channel parameters can be provided as input to one or more machine learning models including transformer models, large language models, small language models, multimodal models, diffusion models, latent diffusion models, and/or generative adversarial networks, where one or more targets can be represented in the content without exact textual reproduction, including by modifying grammar, tense, and/or order of terms for multi-term targets. In some implementations, the generated content can include a realistic or virtual user representation associated with the product, and for video generation, the representation can be caused to speak audio relating to the product based at least on the selected targets.

The method 400 can include synchronizing content to the electronic resource (440). The generated content can be transmitted to one or more destination channels following content generation at 435, such as to online marketplaces, websites, web applications, mobile applications, image presentation channels, video presentation channels, and/or social media systems. The transmission can be triggered based on a command received at an interface for synchronizing the content to the destination channels 150, such as a selection of a synchronization button presented in a user interface. The content can be formatted according to one or more formatting constraints and/or criteria associated with each destination channels, and a state of the content on the destination channels can be monitored to present an indication of successful synchronization or an indication of an error associated with the synchronization. The status of updates on each destination channel can be tracked, and performance metrics for the synchronized content, such as engagement metrics, clickthroughs, search volume, and/or purchase event metrics, can be monitored following synchronization. Subsequent updates to the content can be caused according to the monitored performance metrics and/or dynamic conditions including seasonality, trend data, and/or audience data.

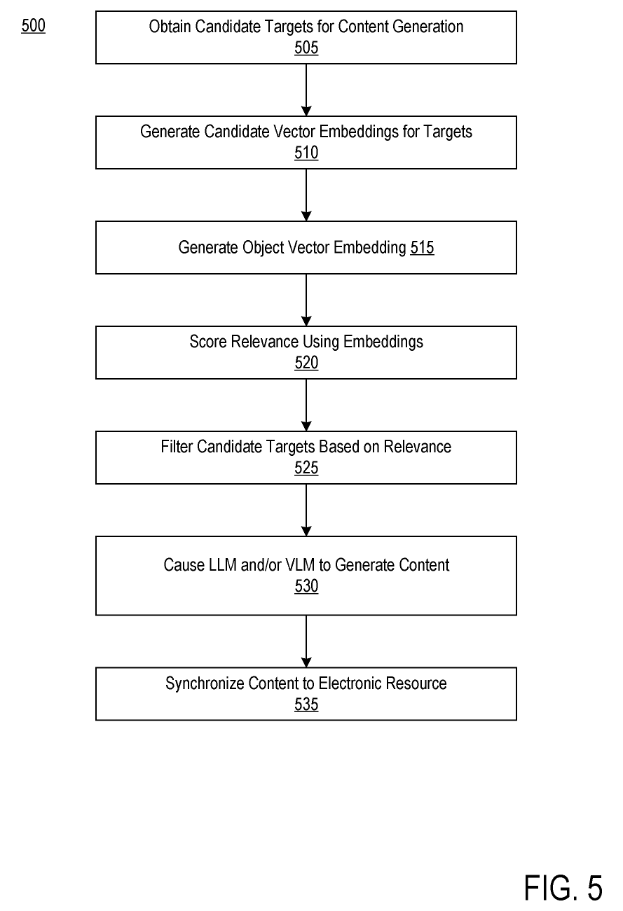

Referring now to FIG. 5, depicted is an illustrative flow diagram of a method 500, such as a method of performance-driven content generation. The method 500 can be executed, performed, or otherwise carried out by any of the computing systems or devices described herein, such as the system 100. In brief overview of the method 500, the method 500 can include obtaining candidate targets for content generation (505), generating candidate vector embeddings for targets (510), generating an object vector embedding (515), scoring relevance using embeddings (520), filtering candidate targets based on relevance (525), causing an LLM and/or VLM to generate content (530), and synchronizing content to the electronic resource (535).

Referring to FIG. 5 in further detail, the method 500 can include obtaining candidate targets for content generation (505). A plurality of candidate targets regarding a product can be obtained from one or more sources, where the candidate targets can include semantic and/or visual descriptors of the product such as characteristics, keywords, classifications, categories, and/or metadata. For example, the candidate targets can be retrieved from predetermined lists of targets, target recommendation services, previously generated or recommended targets, search term reports, keyword reports, and/or targets associated with search traffic for the product. The candidate targets can be obtained in response to receiving an instruction to generate or update a product listing, and/or in response to detecting a content generation condition based on monitoring of product performance data, such as a detection that a performance metric for a product listing has decreased below a threshold. The candidate targets can be retrieved from one or more data sources containing performance data such as advertisement sales data and search volume data, as well as product data including text, image, audio, and/or video information relating to the product. In some implementations, for a new product that has not had a listing published or has not had sufficient listing data captured, the candidate targets can be generated according to product information, search information, or combinations thereof to address cold-start situations in which existing performance data is unavailable or is not sufficient for reliable target retrieval.

The method 500 can include generating candidate vector embeddings for targets (510). A respective target embedding can be generated for each candidate target obtained at 505, where each target embedding can be a vector representation of the candidate target in a vector space. Each candidate target can be processed through one or more embedding models, such as one or more bidirectional encoder representations from transformers (BERT), sentence transformers, and/or language models, to generate a numerical vector representation of the semantic content of each candidate target. The candidate vector embeddings can be generated by applying a selected embedding model to each candidate target, where the embedding model can be pre-trained, trained, and/or fine-tuned using labeled datasets of targets, products, and indications of whether the targets are relevant or not relevant to corresponding products. The embedding model can be selected according to one or more model performance metrics including accuracy, precision, recall, and/or F1 score, such as by evaluating multiple candidate embedding models against labeled data using discrimination metrics including receiver operating characteristic (ROC) curves and selecting the model that provides a sufficient tradeoff for production use.)

The method 500 can include generating an object vector embedding (515). The object vector embedding can be generated based on product information regarding the product, where the product information can include one or more modalities including text, image, audio, and/or video information regarding the product. For example, a text description of the product, an image of the product, audio regarding the product, and/or a video of the product can be processed through the embedding model to generate a product embedding in the same or a compatible vector space as the candidate vector embeddings. The same or a compatible embedding model can be applied to the product information to map the product information into a shared vector space with the candidate target embeddings, which can allow for evaluation of semantic similarity across modalities. In some implementations, multimodal product data including text, image, and/or video representations of the product can be incorporated into the object vector embedding by mapping each modality into the shared vector space, which can allow for cross-modal relevance assessment between targets and products.

The method 500 can include scoring relevance using embeddings (520). A similarity can be computed between each candidate vector embedding generated and the object vector embedding to produce a numerical relevance score for each candidate target. For example, a cosine similarity operation can be performed on each candidate target embedding and the product embedding, yielding a relevance score that indicates a degree of semantic correspondence between the candidate target and the product in the shared vector space. The relevance score can be computed using the cosine similarity, a dot product, and/or a learned similarity model applied to the target embedding and the product embedding. In some implementations, language-specific and/or category-specific relevance scores can be determined by applying language-specific configurations and/or category-specific thresholds to the similarity computation to account for distributions of relevance scores that may vary across languages and/or marketplaces.

The method 500 can include filtering candidate targets based on relevance (525). The relevance score of each candidate target can be compared to one or more discrimination thresholds to classify each candidate target as relevant or not relevant, and candidate targets classified as not relevant can be discarded from further processing. The discrimination threshold can be determined globally, per language, and/or per category, and can be optimized according to a weighted cost function that balances false positives and false negatives such that candidate targets having a relevance score below the discrimination threshold are removed and remaining candidate targets that satisfy the threshold are retained for downstream content generation. The retained candidate targets can be ranked by relevance score, performance data including advertisement sales and/or search volume, and/or a composite ranking score determined using normalization and a weighting function applied to relevance, advertisement sales, and/or search volume data. A subset of the retained candidate targets can be selected for content generation, where the subset can include a top-number subset and/or a subset satisfying a composite ranking score, and where candidate targets associated with a different entity from the entity of the product, such as brand names and/or product names not associated with the product, can be filtered out based on entity-associated criteria prior to selection of the subset.

The method 500 can include causing an LLM and/or VLM to generate content (530). The relevance-qualified selected targets and/or one or more channel parameters for can be provided as input to one or more machine learning models, such as transformer models, large language models, small language models, multimodal models, diffusion models, latent diffusion models, and/or generative adversarial networks, to generate content representative of the product. The content can be generated as text, image, audio, speech, and/or video content, where text content can include a title, bullet point descriptions, and/or backend fields incorporating the selected targets, and where image and/or video content can include representations of the product, one or more realistic or virtual user representations, and/or text information relating to the targets. One or more targets can be represented in the generated content without exact textual reproduction, including by modification of grammar, tense, and/or order of terms for multi-term targets. In some implementations, channel-specific instances of content for different destination channels can be generated using common selected targets together with different channel parameters, such that the instances of content share descriptive similarities while having variations in structure, feature inclusion, and/or grammar to account for variations in criteria for each destination channel.

The method 500 can include synchronizing content to the electronic resource (535). The generated content can be transmitted to one or more destination channels following content generation, where the transmission can be directed to online marketplaces, websites, web applications, mobile applications, image presentation channels, video presentation channels, and/or social media systems. The content can be formatted according to one or more formatting constraints and/or criteria associated with each destination channel prior to transmission, such that the formatted content conforms to channel-specific data schemas and field-level constraints indicated by the channel parameters retrieved from the one or more data sources. A state of the content on each destination channel can be monitored following transmission to present an indication of successful synchronization and/or an indication of an error associated with the synchronization. Performance metrics for the synchronized content, such as engagement metrics, clickthroughs, search volume, and/or purchase event metrics, can be monitored after synchronization, and subsequent updates to the content can be caused according to the monitored performance metrics and/or dynamic conditions including seasonality, trend data, and/or audience data.

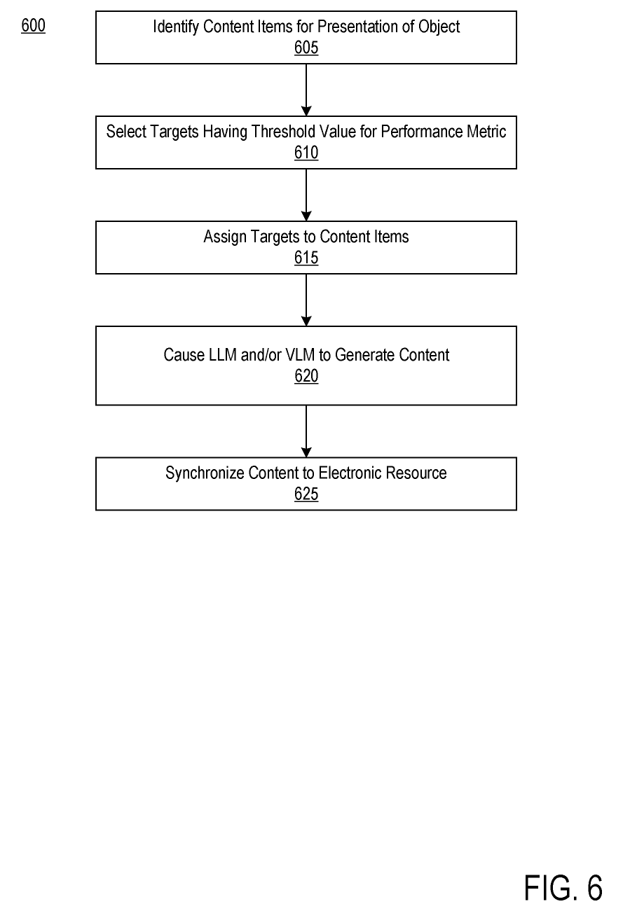

Referring now to FIG. 6, depicted is an illustrative flow diagram of a method 600, such as a method of performance-driven content generation. The method 600 can be executed, performed, or otherwise carried out by any of the computing systems or devices described herein, such as the system 100. In brief overview of the method 600, the method 600 can include identifying content items for presentation of an object (605), selecting targets having a threshold value for a performance metric (610), assigning targets to content items (615), causing an LLM and/or VLM to generate content (620), and synchronizing content to an electronic resource (625).

The method 600 can include identifying content items for presentation of an object (605). A plurality of content items associated with a product listing for the object can be identified, where the content items can include distinct fields and/or sections of a listing such as a title field, one or more bullet point fields, a description field, one or more backend keyword fields, one or more image fields, and/or one or more video fields. The content items can correspond to individual listing components that are defined by channel parameters for a destination channel, where each content item can have distinct character limits, formatting constraints, disallowed terms or characters, and/or target restrictions. The content items can be identified by retrieving channel parameters from one or more data sources, where the channel parameters can indicate a structure and/or syntax for the content including field-specific constraints and a level of compliance for each parameter such as mandatory constraints and/or best practices. For example, the channel parameters can include parameters relating to image and/or video content, such as target locations in an image for portions of content to be provided including a brand banner in a first target location, a product name in a second target location, and an image of the product in a third target location.

The method 600 can include selecting targets having a threshold value for a performance metric (610). A plurality of targets regarding the product can be selected based at least on performance data regarding the product, where the performance data can correspond to completion of an event associated with the product such as at least one of a purchase event for the product and/or a navigation event from an electronic advertisement to a listing page for the product. Candidate targets can be retrieved from one or more sources including predetermined lists of targets, target recommendation services, search term reports, keyword reports, and/or targets associated with search traffic, and each candidate target can be associated with performance metrics including advertisement sales data, search volume data, conversion rate data, clickthrough rate data, and/or engagement event data. The targets can be selected by applying minimum thresholds to the performance metrics to verify data sufficiency, normalizing the performance metrics within a grouping such as per product and/or per target type to obtain comparable scores, computing a composite rank score using a weighted combination of performance metrics such as advertisement sales volume and efficiency metrics, and selecting targets having a composite ranking score that satisfies the threshold value. In some implementations, the targets can be assigned to rank categories such as high, medium, and/or low, and targets having a ranking score greater than the threshold and/or targets belonging to a high ranking category can be selected, where the selection can be constrained by listing field size, image or video size, and/or character or word limits associated with the content items identified at 605.

The method 600 can include assigning targets to content items (615). Each selected target can be assigned to one or more of the content items, where the assignment can map each selected target to a field and/or section of the product listing such as a title section, a bullet point section, and/or a description section. Higher-ranked targets can be assigned to more prominent content items such as a title field, and remaining targets can be distributed across bullet point fields, description fields, and/or backend keyword fields according to the field-specific constraints and character limits associated with each content item. For each content item, a subset of the selected targets that corresponds to the presentation constraints of the content item can be determined, where the presentation constraints can include character limits, formatting restrictions, and/or target restrictions defined by the channel parameters for the destination channel. In some implementations, each target can be associated with a selectable user interface element (e.g., a selectable check box) that can control granular inclusion and/or exclusion of the target in a given content item, such that the assignment can be adjusted via the user interface.

The method 600 can include causing an LLM and/or VLM to generate content (620). The selected targets assigned to the content items can be provided, together with channel parameters and target-to-content-item assignments, as input to one or more machine learning models including transformer models, large language models, small language models, multimodal models, diffusion models, latent diffusion models, and/or generative adversarial networks, such that content representative of the product can be generated for each content item as text, image, audio, speech, and/or video content. For example, text content including a title and bullet point descriptions incorporating the selected targets can be generated, and image and/or video content including representations of the product, one or more realistic or virtual user representations, and text information relating to the targets can be generated based at least on the target-to-content-item mapping and the structure, syntax, and formatting constraints of the destination channel for each content item. In some implementations, one or more targets can be represented in the generated content without exact textual reproduction of the targets, including by modification of grammar, tense, and/or order of terms for multi-term targets, such that the generated content conforms to natural language conventions of the destination channel while preserving the semantic content of the selected targets. In some implementations, channel-specific instances of content for different destination channels can be generated using common selected targets together with different channel parameters, and content can be generated as an update to previous content that includes or represents the selected targets to improve the expected performance of the content on the destination channel.

The method 600 can include synchronizing content to the electronic resource (625). The synchronization can be triggered based on a command received at an interface, such as a selection of a synchronization button presented in the interface. The content can be transmitted to each destination channel according to one or more formatting constraints and/or criteria associated with the destination channel, and a state of the content on the destination channel 150 can be monitored to present an indication of successful synchronization and/or an indication of an error associated with the synchronization. Performance metrics for the synchronized content, such as engagement metrics, clickthroughs, search volume, and/or purchase event metrics, can be monitored following synchronization. Subsequent updates to the content can be caused according to the monitored performance metrics and/or dynamic conditions including seasonality, trend data, and/or audience data.

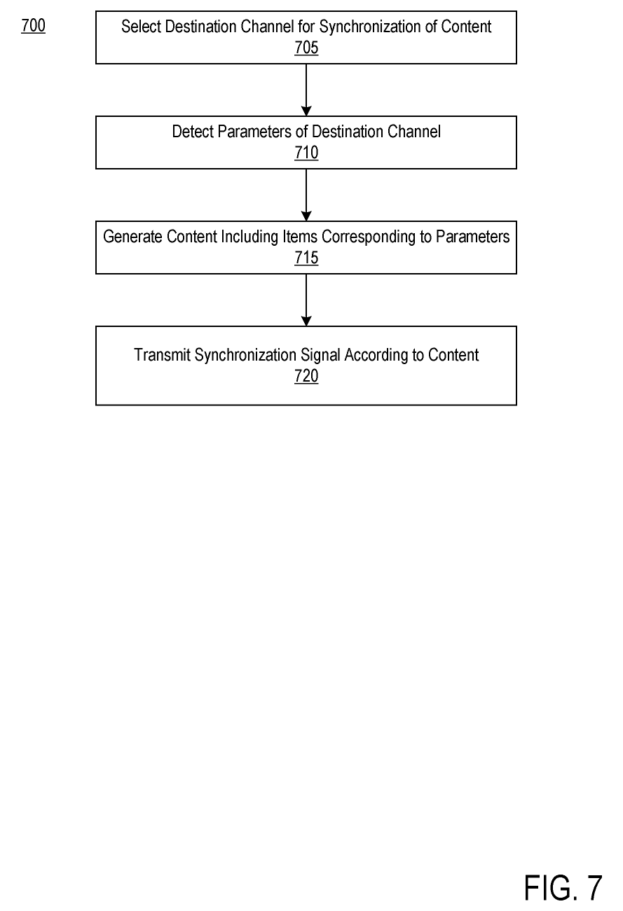

Referring now to FIG. 7, depicted is an illustrative flow diagram of a method 700, such as a method of generating channel-specific content. The method 700 can be executed, performed, or otherwise carried out by any of the computing systems or devices described herein, such as the system 100. In brief overview of the method 700, the method 700 can include selecting a destination channel for synchronization of content (705), detecting parameters of the destination channel (710), generating content including items corresponding to parameters (715), and transmitting a synchronization signal according to content (720).

The method 700 can include selecting a destination channel for synchronization of content (705). A destination channel for synchronization of content can be selected, where the destination channel can be an electronic system that stores data regarding and/or presents the content. For example, the destination channel can include an online marketplace, a website, a web application, a mobile application, an image presentation channel, a video presentation channel, a social media website or application, or various combinations thereof. The selection can be performed in response to receiving an instruction to update product listings on the destination channel, such as a command received at an interface indicating the destination channel to which the content is to be synchronized. The destination channel can be determined based on a channel identifier stored in one or more data sources, where the channel identifier can correspond to a respective set of channel parameters maintained for the destination channel. In some implementations, the destination channel can be selected from a plurality of available destination channels, such as by a selection of the destination channel received via an interface element or by a determination of the destination channel based on a product listing configuration that maps the product to one or more channels.

The method 700 can include detecting parameters of the destination channel (710). A plurality of parameters of the destination channel can be detected, the plurality of parameters including at least one of a natural language description or a machine-readable description, for at least one of a structure, a syntax, or a format for the content. The parameters can include content size constraints, character limits, formatting restrictions, disallowed terms or characters, target restrictions, field-specific constraints, and/or a level of compliance for each parameter such as mandatory constraints and best practices. The parameters can be detected in response to the selection of the destination channel, such as by retrieval of stored channel parameters from one or more data sources or by parsing of one or more policy documents associated with the destination channel using the at least one of the LLM or the VLM. Structured or unstructured indications of criteria for the content, including checklists and/or specifications that may be in a natural language format, can be retrieved from the one or more data sources and processed by the LLM or VLM without a separate manual or NLP operation to extract the parameters. In some implementations, the parameters can include parameters relating to generation of image and/or video content, such as target locations in an image for portions of content to be provided including a brand banner in a first target location, a product name in a second target location, and an image of the product in a third target location.

The method 700 can include generating content including items corresponding to parameters (715). The content can be generated using at least one of the LLM or the VLM, based at least on the plurality of targets selected for the object and the plurality of parameters, where each content item of a plurality of items regarding the object can be generated to correspond to one or more respective parameters of the plurality of parameters. For example, text content including titles, bullet point descriptions, and/or backend keyword fields, as well as image content and/or video content, can be generated such that each content item conforms to the field-specific constraints and formatting restrictions indicated by the detected parameters for the destination channel. Each target of the plurality of targets can be mapped to at least one corresponding item of the plurality of items based at least on the plurality of parameters, such as by assignment of a first target to a first item and a second target to a second item according to the field-specific constraints and/or character limits of each item. In some implementations, a validation of the content relative to the plurality of parameters can be performed using the at least one of the LLM or the VLM (e.g., by querying the at least one of the LLM or the VLM to score a compliance of the content relative to the plurality of parameters), and an error can be output responsive to detection of noncompliance of the content relative to the plurality of parameters.

The method 700 can include transmitting a synchronization signal according to content (720). The synchronization signal can include the content data and instructions to update a data structure regarding the object according to the content. For example, the synchronization signal can include instructions to update a product listing on the destination channel, such as to populate one or more content items associated with the object for presentation of the content on the destination channel. The content can be formatted according to channel-specific data schemas and transmitted as one or more API requests directed to the destination channel, and a synchronization state record can be maintained that stores a status value indicating whether the transmission has been received, processed, and/or published by the destination channel. In some implementations, the transmission of the synchronization signal can be caused based at least on a validation of the content against the plurality of parameters, such that the content is validated for compliance with the channel parameters prior to transmission of the synchronization signal to the destination channel.

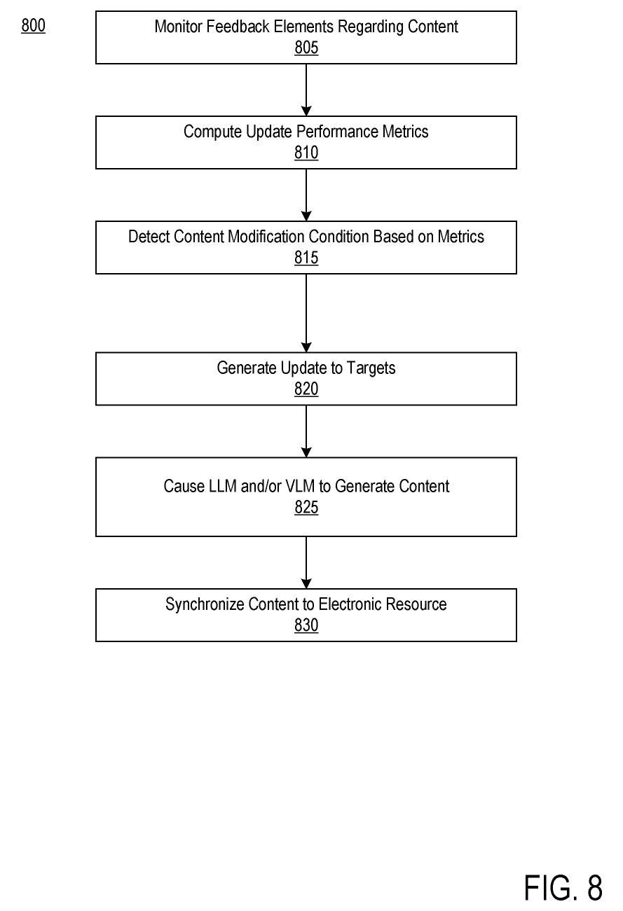

Referring now to FIG. 8, depicted is an illustrative flow diagram of a method 800, such as a method of performance-based content synchronization. The method 800 can be executed, performed, or otherwise carried out by any of the computing systems or devices described herein, such as the system 100. In brief overview of the method 800, the method 800 can include monitoring feedback elements regarding content (805), computing updated performance metrics (810), detecting a content modification condition based on metrics (815), generating an update to targets (820), causing an LLM and/or VLM to generate content (825), and synchronizing content to an electronic resource (830).

The method 800 can include monitoring feedback elements regarding content (805). The feedback elements can include event data relating to engagement actions such as a period of time in which a user interface of a device is directed to or focused on a listing, navigation events such as a clickthrough from an electronic advertisement to a listing page for the product, conversion events such as adding the product to an electronic cart or completing an electronic purchase, and/or search events such as a query that returned the listing in a search result set on the electronic resource. The monitoring can be performed after the content representation has been synchronized to the electronic resource, and can be triggered based on at least one of a command or expiration of a monitoring timer at periodic intervals and/or event-driven intervals following synchronization of the content. One or more data requests can be transmitted to each destination channel at the one or more intervals to retrieve data relating to electronic events corresponding to performance of the content on the destination channel, where the event data can include event identifiers, event timestamps, event types, and/or event counts associated with the content on the destination channel. In some implementations, event data can be received from the destination channels via callback notifications and/or webhook registrations, such that event data is transmitted by the destination channel upon occurrence of an electronic event rather than in response to a polling request.

The method 800 can include computing updated performance metrics (810). Based at least on the one or more feedback elements , an updated performance metric regarding completion of the one or more electronic interactions can be computed. The updated performance metric can correspond to completion of one or more electronic interactions including a site visit to a site of the electronic resource that provides the content representation and/or an interaction with a transaction user interface element provided for the object, such as an add-to-cart button, a purchase button, or a subscription button. The event data stored in one or more data sources can be retrieved, and performance metrics such as engagement rate, clickthrough rate, conversion rate, and/or search impression volume can be computed over a time window corresponding to a predefined evaluation period. The computed performance metrics can be associated with a content identifier and/or a listing identifier for the product, such that the performance metrics are available for use in subsequent content modification and/or target re-ranking operations.

The method 800 can include detecting a content modification condition based on metrics (815). For example, the content modification condition can include a determination that a performance metric for the content on the destination channel has fallen below a threshold value for at least a predefined duration, such as a predefined number of consecutive evaluation periods and/or a predefined elapsed time window during which the performance metric remains below the threshold value. The content modification condition can be detected based at least on monitoring the one or more feedback elements over a predetermined duration and comparing the updated performance metric to a prior value for the performance metric detected over a same amount of time as the predetermined duration, such as by computing a first value for a performance metric based on feedback elements received during a first time window and comparing the first value to a second value for the performance metric based on feedback elements received during a preceding second time window. The content modification condition can be determined to be satisfied when a difference between the first value and the second value satisfies a threshold change magnitude, such as a percentage decrease or an absolute decrease that exceeds a predefined change threshold. The detection can be performed after computing the updated performance metrics at 810, such that the computed metrics can be compared to one or more threshold values to determine whether the content modification condition is satisfied.

The method 800 can include generating an update to one or more targets (820). Responsive to detecting the content modification condition , an update of one or more targets of the plurality of targets can be generated to obtain a set of updated targets. The one or more feedback elements can be mapped to one or more corresponding targets of the plurality of targets based at least on one or more identifiers of the corresponding targets indicated for the one or more feedback elements, and the one or more corresponding targets can be selected for updating according to the mapping. The update can be performed based at least on a weighted attribution of the updated performance metric to one or more targets of the plurality of targets, where a first attribution weight can be assigned to a target mapped to a title content item and a second attribution weight can be assigned to a target mapped to a description content item, such that targets mapped to content items receiving a higher attribution weight relative to other content items can be prioritized for re-ranking and/or re-selection. A given target of the plurality of targets having an initial value greater than a threshold for the performance metric can be excluded from the update of the content representation responsive to an updated value according to the one or more feedback elements for the given target being less than the threshold, such that targets whose performance has degraded below the threshold are removed from the set of targets used for content generation. The plurality of targets can be periodically updated according to performance metrics determined for the plurality of targets, and a re-ranking and/or re-selection of the plurality of targets can be caused in response to the detected content modification condition.

The method 800 can include causing an LLM and/or VLM to generate content (825). At least one of a large language model (LLM) or a vision language model (VLM) can be caused to generate an update of the content representation using the set of updated targets. The updated content can be generated as text, image, audio, speech, and/or video content representative of the product and representative of the updated targets, where the content generation can be performed after the set of updated targets is generated such that the updated targets are received as input to regenerate the content representation. The updated content can be generated according to channel parameters for one or more destination channels, and channel-specific instances of updated content for different destination channels can be generated using the updated targets together with different channel parameters. The updated content can be generated to represent the updated targets without exact textual reproduction of the targets, including by modification of grammar, tense, and/or order of terms for multi-term targets.

The method 800 can include synchronizing content to the electronic resource (830). The update of the content representation generated can be synchronized to the electronic resource. For example, the updated content can be transmitted to the destination channel via one or more API requests, and a synchronization state record can be updated to reflect the status of the transmission. The synchronization can be performed after the updated content is generated , such that the updated content representation is included in a synchronization signal directed to the electronic resource. The synchronization signal can be transmitted in response to completion of the content generation operation or in response to a command received at an interface for synchronizing the content, and the updated content can be formatted according to channel-specific data schemas prior to transmission. The state of the updated content on the destination channel can be monitored following synchronization, such as to present an indication of successful synchronization or an indication of an error associated with the synchronization, and the performance of the updated content on the destination channel can continue to be monitored to detect subsequent content modification conditions that may trigger further iterations of one or more operations of the method 800.

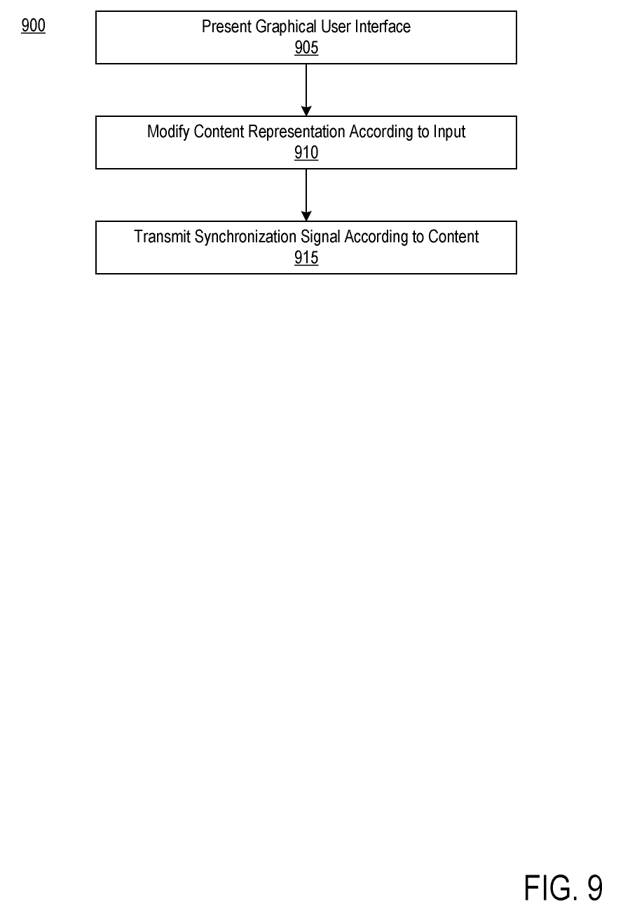

Referring now to FIG. 9, depicted is an illustrative flow diagram of a method 900, such as a method of dynamic content generation interface operation. The method 900 can be executed, performed, or otherwise carried out by any of the computing systems or devices described herein, such as the system 100. In brief overview of the method 900, the method 900 can include presenting a graphical user interface (905), modifying a content representation according to input (910), and transmitting a synchronization signal according to content (915).

The method 900 can include presenting a graphical user interface (905). The graphical user interface can include at least a first portion and a second portion can be presented, the first portion including a sorted list of targets regarding performance for completion of one or more events regarding at least one object, and the second portion including a content representation regarding the at least one object and an indication of one or more updates to the content representation corresponding to one or more targets of the sorted list of targets. The first portion can map the targets to fields and/or sections of the listing to be generated using the content, such as to a title section and/or to a bullet or description section, and each target can be associated with a selectable user interface element such as a selectable check box that can control granular inclusion and/or exclusion of targets in the content. The sorted list of targets can be generated based at least on a score of relevance of each target of the sorted list of targets to the at least one object, and a first subset of the sorted list of targets having a score for the performance greater than a threshold can be presented using a first graphical characteristic while a second subset of the sorted list of targets having a score of the performance less than the threshold can be presented using a second graphical characteristic. In some implementations, the second portion can present the content representation in a format corresponding to presentation of the content representation on a remote device, such as to display the content as the content would appear on the destination channel, and the second portion can present an initial state of the content as well as an updated state of the content to facilitate review and/or editing of updates made, where the indication of the one or more updates can be pre-populated in the second portion responsive to activation of the graphical user interface and confirmed for inclusion in the content representation responsive to a received input.

The method 900 can include modifying a content representation according to an input received via the graphical user interface (910). The content representation can be modified according to a user input received via a first graphical user element associated with the content representation. The input can be received as a natural language text or audio instruction to modify the content representation, or the input can be received as a modification to a format, content, or syntax of the one or more targets. The modification can be performed after the graphical user interface is presented at 905, such that the graphical user interface provides the interface through which the input is received and the content representation is modified. A listing of each of the plurality of candidate targets can be maintained, and on a first interface, the subset of candidate targets can be presented, while on a second interface responsive to a request received via the first interface, the listing of each of the plurality of candidate targets can be presented. The input can be applied to update the content representation by modifying, inserting, removing, and/or reordering content within one or more content items of the content representation via one or more graphical user interface elements presented in the graphical user interface, such as text input fields, selectable check boxes associated with individual targets, and/or natural language instruction fields.

The method 900 can include transmitting a synchronization signal according to the content (915). The synchronization signal can be transmitted to a destination channel responsive to receiving a synchronize command via a second graphical user element associated with the content representation, the synchronization signal including the content representation. The synchronization signal can include the modified content representation and instructions to update one or more content items associated with the object for presentation of the content data on the destination channel. The transmission can be performed after modification of the content representation at 910, such that the modified content representation is included in the synchronization signal directed to the destination channel, and the transmission can be triggered by a selection of a synchronization button and/or other graphical user interface element presented in the graphical user interface. The content representation can be formatted according to channel-specific data schemas and transmitted as one or more API requests directed to the destination channel, and a state of the content on the destination channel can be monitored to present an indication of successful synchronization and/or an indication of an error associated with the synchronization. A synchronization state record that stores a status value indicating whether the transmission has been received, processed, and/or published by the destination channel can be maintained, and the status value can be presented at the graphical user interface as a visual indicator reflecting the current synchronization state.

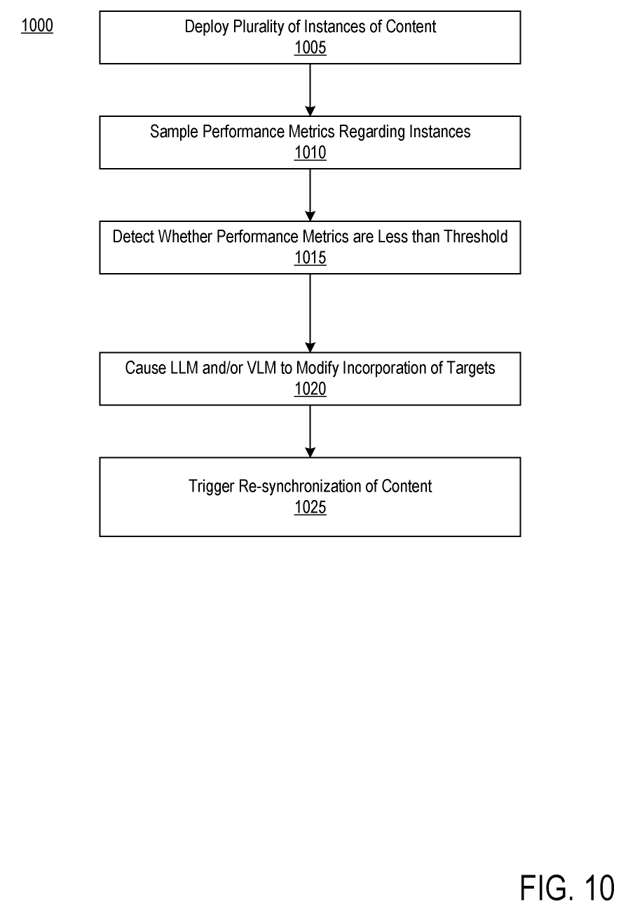

Referring now to FIG. 10, depicted is an illustrative flow diagram of a method 1000, such as a method of dynamic content updating according to performance monitoring. The method 1000 can be executed, performed, or otherwise carried out by any of the computing systems or devices described herein, such as the system 100. In brief overview of the method 1000, the method 1000 can include deploying a plurality of instances of content (1005), sampling performance metrics regarding instances (1010), detecting whether performance metrics are less than a threshold (1015), causing an LLM and/or VLM to modify incorporation of targets (1020), and triggering re-synchronization of content (1025).

The method 1000 can include deploying a plurality of instances of content (1005). Each instance of the plurality of instances can be generated from one or more targets of a plurality of targets. A first instance of the plurality of instances can include a first variant of the one or more targets, a second instance of the plurality of instances can include a second variant of the one or more targets, and the second variant can be different from the first variant. The first variant and the second variant can be generated to be different in syntax and to have less than a threshold difference in content as indicated by an embedding of the first variant and an embedding of the second variant, such that the variants share semantic similarity while differing in surface-level textual expression. The deployment can be performed in response to a content generation operation in which a plurality of content instances are generated for A/B testing and/or multivariate testing across one or more destination channels and/or segments of destination channels. The plurality of instances can be deployed according to a schedule, such as at a predetermined time and/or at regular intervals, to facilitate controlled comparison of the performance of each variant over a test campaign period. Each instance of the plurality of instances can be transmitted to a respective destination channel and/or segment of a destination channel via one or more API requests, and each instance can be formatted according to channel-specific data schemas and field-level constraints indicated by channel parameters retrieved from one or more data sources 108.

The method 1000 can include sampling performance metrics regarding instances (1010). One or more performance metrics regarding each of the first instance and the second instance can be sampled, where the performance metrics can include electronic event completion metrics such as engagement metrics, clickthrough rates, search volume, conversion rates, and/or purchase event metrics. The one or more performance metrics can be determined according to event data detected from an electronic resource on which the first instance and the second instance are deployed. The sampling can be performed over a test campaign period, during which one or more metrics for the content on each channel or channel segment to which the instances are deployed are monitored at periodic intervals and/or event-driven intervals. The one or more performance metrics can be normalized according to an overall electronic communication metric traffic associated with one or more destination channels on which the first instance and the second instance are deployed, such that variations in overall traffic volume across channels or time periods do not distort the comparison between the first instance and the second instance. A normalized engagement rate for each instance can be computed by dividing engagement event counts by a total impression count or total traffic count for the respective channel segment, such that the performance metrics for the first instance and the second instance are comparable across segments or channels with different traffic volumes.

The method 1000 can include detecting whether performance metrics are less than a threshold (1015). Based at least on the sampling, a determination can be made as to whether the one or more performance metrics for at least one of the first instance or the second instance are less than a performance threshold, where the performance threshold can correspond to a minimum acceptable engagement rate, clickthrough rate, conversion rate, and/or composite performance score. The sampled performance metrics for each deployed instance can be compared to the performance threshold to identify instances that are underperforming relative to a target performance level. The detection can be performed after sampling the performance metrics, such that the comparison to the performance threshold occurs once sufficient event data has been collected over the test campaign period, and can be triggered at periodic evaluation intervals within the test campaign period and/or upon expiration of the test campaign period, such that performance can be evaluated at predetermined checkpoints to determine whether remedial content modification is warranted. The performance metrics of the first instance and the performance metrics of the second instance can be compared to the performance threshold, and the instance of the first instance or the second instance having performance metrics below the performance threshold can be identified. In some implementations, a dashboard including the one or more performance metrics for the first instance and the second instance can be presented, such as to provide an output indicative of the one or more metrics over the test campaign period that can be used for subsequent optimization decisions.

The method 1000 can include causing an LLM and/or VLM to modify incorporation of targets (1020). The one or more targets of at least one of the first instance or the second instance can be modified by at least one of a large language model (LLM) or a vision language model (VLM), based at least on the one or more performance metrics being less than the performance threshold. For example, a request to update the content to match the higher scoring content according to the test can be presented, and/or the content can be automatically updated to match the higher scoring content, such that the underperforming instance is modified to incorporate target variants associated with higher performance. The incorporation of the one or more targets can be modified by adjusting syntax, grammar, tense, ordering of multi-term targets, and/or selection of different targets from the plurality of targets based at least on the performance metrics, without exact textual reproduction of the targets in the modified content. The modification can be triggered responsively to the detection that one or more performance metrics are less than the performance threshold, such that updated targets and/or a modified variant of the one or more targets are received as input to the LLM and/or VLM for regeneration of the content output. In some implementations, the sampling, detection, and operation of the at least one of the LLM or the VLM can be performed iteratively until a performance improvement condition is satisfied, such that the content is repeatedly modified and evaluated until the performance metrics satisfy the performance threshold or a predefined number of iterations is reached.

The method 1000 can include triggering re-synchronization of content (1025). A re-synchronization of the at least one of the first instance or the second instance can be triggered based at least on the modification of the incorporation of the one or more targets. For example, the modified content instance can be transmitted to the destination channel or channel segment on which the underperforming instance was previously deployed, such that the modified content replaces the prior content on the destination channel. The re-synchronization can be triggered automatically upon completion of the modification operation, or can be triggered in response to a synchronize command received via a user interface element. The modified content can be formatted according to channel-specific data schemas and transmitted as one or more API requests directed to the destination channel, and a synchronization state record can be maintained that stores a status value indicating whether the re-synchronization has been received, processed, and/or published by the destination channel. The state of the re-synchronized content on the destination channel can be monitored to present an indication of successful synchronization or an indication of an error associated with the synchronization, and performance metrics for the re-synchronized content can continue to be sampled to determine whether further iterations of the method 1000 are warranted.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein can be implemented or performed with a general purpose single- or multi-chip processor, a digital signal processor (DSP), an application specific integrated circuit (ASIC), a field programmable gate array (FPGA), graphical processing unit (GPU) or other programmable logic device, discrete gate or transistor logic, discrete hardware components, or any combination thereof designed to perform the functions described herein. A general purpose processor can be a microprocessor, or, any conventional processor, controller, microcontroller, soc (system on chip), som (system on module) or state machine. A processor also can be implemented as a combination of computing devices, such as a combination of a DSP and a microprocessor, a plurality of microprocessors, one or more microprocessors in conjunction with a DSP core, or any other such configuration. In some implementations, particular processes and methods can be performed by circuitry that is specific to a given function. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. The memory can be or include volatile memory or non-volatile memory, and can include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure can be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Systems and methods described herein can be embodied in other specific forms without departing from the characteristics thereof. Further relative parallel, perpendicular, vertical or other positioning or orientation descriptions include variations within +/-10% or +/-10 degrees of pure vertical, parallel or perpendicular positioning. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and that such variations are intended to be encompassed by the present disclosure.

What is claimed is:

1. A system, comprising:
one or more processors to:
monitor one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object;
compute, based at least on the one or more feedback elements, an updated performance metric regarding completion of the one or more electronic interactions;
detect a content modification condition based at least on the updated performance metric;
generate, responsive to detecting the content modification condition, an update of one or more targets of the plurality of targets, to obtain a set of updated targets;
cause at least one of a large language model (LLM) or a vision language model (VLM) to generate an update of the content representation using the set of updated targets; and
synchronize the update of the content representation to the electronic resource.

2. The system of claim 1, wherein the one or more processors are to detect the content modification condition based at least on monitoring the one or more feedback elements over a predetermined duration and comparing the updated performance metric to a prior value for the performance metric detected over a same amount of time as the predetermined duration.

3. The system of claim 1, wherein the one or more processors are to compute the updated performance metric to correspond to completion of one or more electronic interactions including at least one of a site visit to a site of the electronic resource that provides the content representation or an interaction with a transaction user interface element provided for the object.

4. The system of claim 1, wherein the one or more processors are to:
map the one or more feedback elements to one or more corresponding targets of the plurality of targets, based at least on one or more identifiers of the corresponding targets indicated for the one or more feedback elements; and
select the one or more corresponding targets for updating according to the mapping.

5. The system of claim 1, wherein the one or more processors are to perform a weighted attribution of the updated performance metric to one or more targets of the plurality of targets to select the one or more targets for modification.

6. The system of claim 1, wherein the one or more processors are to trigger evaluation of the content modification condition based on at least one of a command or expiration of a monitoring timer.

7. The system of claim 1, wherein the initial value is greater than a threshold for the performance metric for a given target of the plurality of targets, and the one or more processors are to exclude the given target from the update of the content representation responsive to an updated value according to the one or more feedback elements for the given target being less than the threshold.

8. A method, comprising:
monitoring, by one or more processors, one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object;
computing, by the one or more processors, based at least on the one or more feedback elements, an updated performance metric regarding completion of the one or more electronic interactions;
detecting, by the one or more processors, a content modification condition based at least on the updated performance metric;
generating, by the one or more processors responsive to detecting the content modification condition, an update of one or more targets of the plurality of targets, to obtain a set of updated targets;
causing, by the one or more processors, at least one of a large language model (LLM) or a vision language model (VLM) to generate an update of the content representation using the set of updated targets; and
synchronizing, by the one or more processors, the update of the content representation to the electronic resource.

9. The method of claim 8, comprising detecting the content modification condition based at least on monitoring the one or more feedback elements over a predetermined duration and comparing the updated performance metric to a prior value for the performance metric detected over a same amount of time as the predetermined duration.

10. The method of claim 8, comprising computing the updated performance metric to correspond to completion of one or more electronic interactions that include at least one of a site visit to a site of the electronic resource that provides the content representation or an interaction with a transaction user interface element provided for the object.

11. The method of claim 8, comprising:
mapping the one or more feedback elements to one or more corresponding targets of the plurality of targets, based at least on one or more identifiers of the corresponding targets indicated for the one or more feedback elements; and
selecting the one or more corresponding targets for updating according to the mapping.

12. The method of claim 8, comprising performing a weighted attribution of the updated performance metric to one or more targets of the plurality of targets to select the one or more targets for modification.

13. The method of claim 8, comprising triggering evaluation of the content modification condition based on at least one of a command or expiration of a monitoring timer.

14. The method of claim 8, wherein the initial value is greater than a threshold for the performance metric for a given target of the plurality of targets, the method comprising excluding the given target from the update of the content representation responsive to an updated value according to the one or more feedback elements for the given target being less than the threshold.

15. A non-transitory computer-readable medium comprising machine-readable instructions that when executed by one or more processors, cause the one or more processors to:
monitor one or more feedback elements regarding a content representation of an object synchronized to an electronic resource, the content representation comprising a plurality of content items corresponding to a plurality of targets, each target of the plurality of targets having an initial value for a performance metric for completion of one or more electronic interactions for the object;
compute, based at least on the one or more feedback elements, an updated performance metric regarding completion of the one or more electronic interactions;
detect a content modification condition based at least on the updated performance metric;
generate, responsive to detecting the content modification condition, an update of one or more targets of the plurality of targets, to obtain a set of updated targets;
cause at least one of a large language model (LLM) or a vision language model (VLM) to generate an update of the content representation using the set of updated targets; and
synchronize the update of the content representation to the electronic resource.

16. The non-transitory computer-readable medium of claim 15, wherein the instructions cause the one or more processors to:
detect the content modification condition based at least on monitoring the one or more feedback elements over a predetermined duration and comparing the updated performance metric to a prior value for the performance metric detected over a same amount of time as the predetermined duration.

17. The non-transitory computer-readable medium of claim 15, wherein the instructions cause the one or more processors to:
compute the updated performance metric to correspond to completion of one or more electronic interactions include a site visit to a site of the electronic resource that provides the content representation, an interaction with a transaction user interface element provided for the object.

18. The non-transitory computer-readable medium of claim 15, wherein the instructions cause the one or more processors to:
map the one or more feedback elements to one or more corresponding targets of the plurality of targets, based at least on one or more identifiers of the corresponding targets indicated for the one or more feedback elements; and
select the one or more corresponding targets for updating according to the mapping.

19. The non-transitory computer-readable medium of claim 15, wherein the instructions cause the one or more processors to:
perform a weighted attribution of the updated performance metric to one or more targets of the plurality of targets to select the one or more targets for modification.

20. The non-transitory computer-readable medium of claim 15, wherein the instructions cause the one or more processors to:
trigger evaluation of the content modification condition based on at least one of a command or expiration of a monitoring timer.
